(19) United States
(12) Patent Application Publication
(10) Pub. No.: US 2022/0251332 A1
(43) Pub. Date: Aug. 11, 2022

(54) FLAME RETARDANT PLOYMER COMPOSITION AND METHODS OF USE

(71) Applicant: IMERYS USA, INC., Roswell, GA (US)

(72) Inventors: Filipe FANTATHO, Jundial-SP (BR); Maziyar BOLOURCHI, Los Gatos, CA (US)

(21) Appl. No.: 17/613,581

(22) PCT Filed: May 22, 2020
(86) PCT No.: PCT/US20/34230

§ 371 Date: Nov. 23, 2021

Related U.S. Application Data
(60) Provisional application No. 62/851,833, filed on May 23, 2019.

(51) Int. Cl. C08K 3/34; C08K 3/26; C08K 3/22; C08K 3/016

(52) U.S. Cl. CPC C08K 3/346; C08K 3/26; C08K 3/22; C08K 2003/265; C08K 2003/2224; C08K 2003/2241; C08K 3/016

(57) ABSTRACT

A flame resistant polymer composition comprising a mineral blend melt-mixed into a polymer matrix is described. The mineral blend comprises an alkaline earth carbonate, kaolin, and magnesium hydroxide. The polymer matrix may comprise ethylene-vinyl acetate and polyethylene, and dicumyl peroxide may also be added. The flame resistant polymer composition shows a UL94 flammability rating of V-0 or V-1, without containing halogens or aluminum hydroxide. The flame resistant polymer composition may be suitable as a wire coating, or for passive fire resistance in vehicles and buildings.

### CLAIM FOR PRIORITY

This PCT International Application claims the benefit of priority of U.S. Provisional Application No. 62/851,833, filed May 23, 2019, the subject matter of which is incorporated herein by reference in its entirety.

### TECHNICAL FIELD

The present disclosure relates to a polymer composition with flame retardant properties and comprising a mineral blend of kaolin, an alkaline earth carbonate, and magnesium hydroxide.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

It is well-known in the art to produce flame-retardant polymer compositions for various functions. The requirements for the various flame-retardancy properties of a polymer composition may vary depending on the intended final use of the polymer composition. For example, the requirements relating to heat release, smoke production, vertical flame propagation, smoke density, smoke acidity, and melt viscosity may vary depending on the intended final use of the polymer composition. It is therefore desirable to provide alternative and/or improved flame-retardant polymer compositions.

In view of the forgoing, one objective of the present disclosure is to provide a polymer composition having flame retardant properties. The composition comprises a mineral blend of kaolin, an alkaline earth carbonate, and magnesium hydroxide. The composition may be free of halogen and aluminum hydroxide.

### BRIEF SUMMARY

According to a first aspect, the present disclosure relates to a flame retardant polymer composition, comprising a mineral blend and a polymer. The mineral blend is present at a weight percent in a range of 20-80 wt %, and the polymer is present at a weight percent in a range of 20-80 wt %, each relative to a total weight of the flame retardant polymer composition. The mineral blend comprises kaolin, an alkaline earth carbonate, and magnesium hydroxide.

In one embodiment, the mineral blend comprises 10-50 wt % kaolin, 10-50 wt % alkaline earth carbonate, and 10-50 wt % magnesium hydroxide, each relative to a total weight of the mineral blend.

In one embodiment, the mineral blend is dispersed in the polymer.

In one embodiment, the kaolin is natural kaolin.

In one embodiment the kaolin is a surface treated kaolin.

In one embodiment, the alkaline earth carbonate is at least one selected from the group consisting of calcium carbonate, magnesium carbonate, dolomite, huntite, and magnesite.

In one embodiment, the polymer is a polyolefin.

In one embodiment, the polymer is an elastomer selected from the group consisting of alkyl acrylate copolymer (acrylic rubber), ethylene propylene diene monomer rubber, ethylene propylene rubber, ethylene-vinyl acetate, fluoroelastomer, polybutadiene, polyisobutylene, polyisoprene, silicone rubber, and natural rubber.

In one embodiment, the polymer is a thermoplastic polymer selected from the group consisting of acrylic, acrylonitrile butadiene styrene, ethylene-vinyl acetate, nylon, poly(vinyl acetate), polyacrylonitrile, polybenzimidazole, polybenzoxazole, polybenzthiazole, polybutene-1, polybutylene, polycarbonate, polyether sulfone, polyetherether ketone, polyetherimide, polyethylene, polyethylene adipate, polyethylene terephthalate, polyimide, polylactic acid, polymethyl acrylate, polymethyl methacrylate, polymethylpentene, polyoxymethylene, polyphenylene oxide, polyphenylene sulfide, polypropylene, polystyrene, polytetrafluoroethylene, polyvinyl alcohol, polyvinyl chloride, polyvinyl ester, and polyvinylidene fluoride.

In a further embodiment, the thermoplastic polymer comprises ethylene-vinyl acetate and polyethylene.

In a further embodiment, the polyethylene is linear low-density polyethylene.

In one embodiment, the flame retardant polymer composition further comprises less than 5 wt % aluminum hydroxide relative to a total weight of the flame retardant polymer composition.

In a further embodiment, the flame retardant polymer composition comprises less than 0.1 wt % aluminum hydroxide relative to a total weight of the flame retardant polymer composition.

In one embodiment, the flame retardant polymer composition is essentially free of halogens.

In one embodiment, the flame retardant polymer composition further comprises titanium dioxide.

In one embodiment, the flame retardant polymer composition further comprises 0.01-5 wt % of a fatty acid, a polysiloxane, or both, each relative to a total weight of the flame retardant polymer composition.

In a further embodiment, the fatty acid is stearin and the polysiloxane is PDMS.

In a further embodiment, the flame retardant polymer composition comprises both fatty acid and polysiloxane at a weight ratio in a range of 1:1-6:1 stearin to polysiloxane.

In one embodiment, the flame retardant polymer composition further comprises 0.01-0.05 wt % dicumyl peroxide, relative to a total weight of the flame retardant polymer composition.

In one embodiment, the flame retardant polymer composition has a density in a range of 1.1-1.8 g/cm³.

In one embodiment, the flame retardant polymer composition has a melt flow rate in a range of 2.0-4.5 cm³/10 min at 150° C. according to ASTM D 1238-10.

In one embodiment, the flame retardant polymer composition has a melt flow rate in a range of 47-70 cm³/10 min at 230° C. according to ASTM D 1238-10.

In one embodiment, the flame retardant polymer composition has a tensile strength at break in a range of 6-10 MPa according to ASTM D 638-14.

In one embodiment, the flame retardant polymer composition has a tensile strain at break in a range of 15-40% according to ASTM D 638-14.

In one embodiment, the flame retardant polymer composition has a UL94 flammability rating of V-0 or V-1.

According to a second aspect, the present disclosure relates to an insulated wire product, comprising an electrically-conductive wire coated with a layer of the flame retardant polymer composition of the first aspect.

According to a third aspect, the present disclosure relates to a method of making the flame retardant polymer composition of the first aspect. This method involves melt-mixing with the polymer a mineral blend selected from: (i) a blend comprising kaolin surface treated (such as with an aminosilane), an alkaline earth carbonate, and magnesium hydroxide; and (ii) a polysiloxane or fatty acid coated mineral blend comprising kaolin, an alkaline earth carbonate, and magnesium hydroxide.

In one embodiment of the method, the mineral blend (i) or (ii) have a mean diameter in a range of 0.5-10 μm.

In one embodiment of the method, the mineral blend (i) or (ii) have a BET surface area in a range of 2-20 m²/g.

In one embodiment of the method, the melt-mixing is done in a screw extruder having an RPM in a range of 100-300 and heated with a temperature gradient having a maximum temperature in a range of 150-250° C.

In one embodiment of the method, the melt-mixing involves first melt-mixing the polymer in a heated screw extruder and then adding the mineral blend to the heated screw extruder.

According to a fourth aspect, the present disclosure relates to a method of forming a flame retardant object. The method involves heating the flame retardant polymer composition of the first aspect to form a molten composition. Then a surface of an object is contacted with the molten composition to form a flame retardant object.

In one embodiment of the method, the object is an electrical conductor, an automotive part, a building material, an electronic device, or an electrical appliance.

According to a fifth aspect, the present disclosure relates to a method of forming a flame retardant object. The method involves injection molding the flame retardant polymer composition of the first aspect to form a flame retardant object.

In one embodiment of the method the flame retardant object forms a housing or an outer surface of an electrical conductor, an automotive part, a building material, an electronic device, or an electrical appliance.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows logarithmic equations representing the temperature profile of the screw extruder.

FIG. 2A shows a schematic diagram of the twin-screw extruder.

FIG. 2B shows another schematic diagram of the twin-screw extruder.

FIG. 3 shows the feeder throughput in zone 3 of the twin-screw extruder.

FIG. 4A shows the torque during the compounding of each sample.

FIG. 4B shows the average die pressure during the compounding of each sample.

FIG. 5 shows the compound density of each sample.

FIG. 6A shows the melt flow rates of the compounds at 150° C.

FIG. 6B shows the melt flow rates of the compounds at 230° C.

FIG. 7A shows tensile strength of the compounds.

FIG. 7B shows tensile strain of the compounds.

FIG. 8 shows the feeder throughput of three minerals at zone 3.

FIG. 9A shows amperage of the extruder when extruding different compounds.

FIG. 9B shows melt flow rates of the compounds.

FIG. 10A shows the tensile strength at break of the compounds.

FIG. 10B shows the tensile strain at break of the compounds.

FIG. 11A shows the tensile strength at break of the compounds, with and without DCP.

FIG. 11B shows the tensile strain at break of the compounds, with and without DCP.

FIG. 12A is picture of specimens with DCP after burning test.

FIG. 12B is picture of specimens without DCP after burning test.

FIG. 13 shows the 20° gloss results of the compounds tested in Example 5.

FIG. 14 shows the 60° gloss results of the compounds tested in Example 5.

### DETAILED DESCRIPTION OF THE EMBODIMENTS

Embodiments of the present disclosure will now be described more fully hereinafter with reference to the accompanying drawings, in which some, but not all embodiments of the disclosure are shown.

The present disclosure will be better understood with reference to the following definitions. As used herein, the words “a” and “an” and the like carry the meaning of “one or more.” Within the description of this disclosure, where a numerical limit or range is stated, the endpoints are included unless stated otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term “and/or” includes any and all combinations of one or more of the associated listed items and may be abbreviated as “/”.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10 it is also envisioned that Parameter X may have other ranges of values including 1-9, 2-9, 3-8, 1-8, 1-3, 1-2, 2-10, 2.5-7.8, 2-8, 2-3, 3-10, and 3-9, as mere examples.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present disclosure that do not contain those elements or features.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present disclosure.

Nothing in the above description is meant to limit the scope of the claims to any specific composition or structure of components. Many substitutions, additions, or modifications are contemplated within the scope of the present disclosure and will be apparent to those skilled in the art. The embodiments described herein were presented by way of example only and should not be used to limit the scope of the claims.

As used herein, “compound” is intended to refer to a chemical entity, whether as a solid, liquid, or gas, and whether in a crude mixture or isolated and purified.

As used herein, “composite” refers to a combination of two or more distinct constituent materials into one. The individual components, on an atomic level, remain separate and distinct within the finished structure. The materials may have different physical or chemical properties, that when combined, produce a material with characteristics different from the original components. In some embodiments, a composite may have at least two constituent materials that comprise the same empirical formula but are distinguished by different densities, crystal phases, or a lack of a crystal phase (i.e. an amorphous phase).

The present disclosure is intended to include all hydration states of a given compound or formula, unless otherwise noted or when heating a material. For example, Ni(NO₃)₂ includes anhydrous Ni(NO₃)₂, Ni(NO₃)₂.6H₂O, and any other hydrated forms or mixtures. CuCl₂ includes both anhydrous CuCl₂ and CuCl₂.2H₂O. Magnesite includes hydromagnesite.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of carbon include ¹³C and ¹⁴C. Isotopes of nitrogen include ¹⁴N and ¹⁵N. Isotopes of oxygen include ¹⁶O, ¹⁷O, and ¹⁸O. Isotopes of magnesium include ²⁴Mg, ²⁵Mg, and ²⁶Mg. Isotopes of calcium include ⁴⁰Mg, ⁴²Mg, ⁴³Mg, ⁴⁴Mg, and ⁴⁶Mg. Isotopes of aluminum include ²⁶Al and ²⁷Al. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

According to a first aspect, the present disclosure relates to a flame retardant polymer composition, comprising a mineral blend and a polymer.

The mineral blend may be present in the flame resistant polymer composition at a weight percent in a range of 20-80 wt %, or 30-75 wt %, or 40-70%, or 50-65 wt %, relative to a total weight of the flame resistant polymer composition. The mineral blend comprises kaolin, an alkaline earth carbonate, and magnesium hydroxide. In alternative embodiments, the mineral blend may comprise other minerals, including but not limited to talc, mica, wollastonite, halloysite, and perlite. Other minerals listed hereinafter may also be considered.

In one embodiment, the mineral blend is dispersed in the polymer. In one embodiment, the mineral blend being dispersed in the polymer means that any contiguous cubic region of 1 mm3 volume within the flame resistant polymer composition has a concentration or density of the mineral blend that is less than 30% different, or less than 20% different, or less than 10% different, or less than 5% different than a bulk (or average) concentration or density of the mineral blend in the polymer. In some embodiments, the flame resistant polymer composition may be spread as a thin layer where a 1 mm3 contiguous cubic volume may not be present, in which case the similar definition may be applied to smaller cubic volumes, for instance, 0.1 mm3, 0.01 mm3, or 0.001 mm3.

The mineral blend may comprise kaolin at a weight percentage in a range of 10-50 wt %, or 20-40 wt %, or 30-35 wt % or about 33 wt %, relative to a total weight of the mineral blend. Kaolins include the minerals kaolinite, dickite, halloysite, and nacrite. Kaolinite is a clay mineral, part of the group of industrial minerals, with the chemical composition Al₂Si₂O₅(OH)₄. It is a layered silicate mineral, with one tetrahedral sheet of silica (SiO₄) linked through oxygen atoms to one octahedral sheet of alumina (AlO₆) octahedra. In one embodiment, the kaolin may be present as particles having a median particle size (d₅₀) in a range of 0.2-5 μm, or 0.8-2 μm, or 0.9-1.9, or 0.9-1.5 μm. In one embodiment, the median particle size is no larger than 1.9 μm.

For example, certain very coarse kaolins have a particle size distribution such that less than about 70% by weight of the particles, less than about 60% by weight of the particles, or less than about 50% by weight of the particles have a particle size of less than 2 microns as measured by Sedigraph®. In contrast, very fine kaolins can have a particle size distribution such that greater than 80% by weight of the particles, greater than 85% by weight of the particles, greater than 90%, or even greater than 95% by weight of the particles have a particle size of less than 2 microns as measured by Sedigraph.

Another way to view the size of a kaolin is by its fine particle content. For example, some very fine kaolins can have a particle size distribution such that greater than 20% by weight of the particles, greater than 25% by weight of the particles, greater than 30%, greater than 40%, or even greater than 50% by weight of the particles have a particle size of less than 0.25 microns as measured by Sedigraph. In contrast, coarse kaolins can have a particle size distribution such that less than 20% by weight of the particles, less than 15% by weight of the particles, or even less than 10% by weight of the particles have a particle size of less than 0.25 microns as measured by Sedigraph.

Kaolin clay can have a wide variety of particle shapes. For example, some blocky kaolins have shape factors of less than about 15, such as less than about 12, less than about 10, less than about 8, less than about 6, or even less than about 4. Other platy kaolins can have shape factors of greater than about 15, such as for example greater than about 20, greater than about 25, greater than about 30, greater than about 35, greater than about 40, greater than about 50, greater than about 70, or even greater than about 100.

“Shape factor”, as used herein, is a measure of the ratio of particle diameter to particle thickness for a population of particles of varying size and shape as measured using the electrical conductivity methods, apparatuses, and equations described in U.S. Pat. No. 5,576,617. As described in the '617 patent, the electrical conductivity of a composition of an aqueous suspension of orientated particles under test is measured as the composition flows through a vessel. Measurements of the electrical conductivity are taken along one direction of the vessel and along another direction of the vessel transverse to the first direction. Using the difference between the two conductivity measurements, the shape factor of the particulate material under test is determined.

In one embodiment, the kaolin is natural kaolin, meaning that the kaolin is sourced from the environment and is not calcined (i.e. not subject to heat greater than 500° C.), or is sourced from the environment and is not processed beyond mechanical processing (grinding, sieving, pelletizing, etc.). In one embodiment, the kaolin may calcined kaolin, or hydrous kaolin. In one embodiment the kaolin to be used in the mineral blend can be a surface treated kaolin. The surface treatment can be an aminosilane, including but not limited to APTES-gamma-aminopropyltriethoxysilane, APDEMS-(3-aminopropyl)-diethoxy-methylsilane, APDMES-(3-aminopropyl)-dimethyl-ethoxysilane, APTMS-(3-aminopropyl)-trimethoxysilane.

The mineral blend may comprise one or more alkaline earth carbonates at a total weight percentage in a range of 10-50 wt %, or 20-40 wt %, or 30-35 wt % or about 33 wt %, relative to a total weight of the mineral blend. In one embodiment, the alkaline earth carbonate is at least one selected from the group consisting of calcium carbonate, magnesium carbonate, dolomite, huntite, and magnesite. The alkaline earth carbonate may comprise a mixture of one or more alkaline earth carbonates, for instance two may be present at a weight ratio in a range of 1:100-100:1, or 1:10-10:1, or 1:2-2:1. In a preferred embodiment, the alkaline earth carbonate is dolomite, which may also be known as calcium magnesium carbonate or CaMg(CO₃)₂. In one embodiment, the alkaline earth carbonate may be present as particles having a median particle size (d₅₀) in a range of 0.5-5 μm, or 0.8-2.5 μm, or 0.9-1.5 μm. In one embodiment, the median particle size is no larger than 2.6 μm. In one embodiment, the mineral blend may comprise dolomite but may not contain calcium carbonate. In one embodiment the flame resistant polymer composition does not contain calcium carbonate. In one embodiment, the alkaline earth metal carbonate may be a calcium carbonate, such as a ground calcium carbonate (e.g., ground marble, ground limestone, or ground chalk) or a precipitated calcium carbonate.

The mineral blend may comprise magnesium hydroxide at a weight percentage in a range of 10-50 wt %, or 20-40 wt %, or 30-35 wt % or about 33 wt %, relative to a total weight of the mineral blend. Magnesium hydroxide may be referred to as MDH. The magnesium hydroxide may, for example, be brucite, chlorite, or a combination of one or more thereof. In one embodiment, the alkaline earth carbonate may be present as particles having a median particle size (d₅₀) in a range of 0.5-5 μm, or 0.8-2.5 μm, or 0.9-1.5 μm. In one embodiment, the median particle size is no larger than 2.5 μm.

When a particulate mineral (e.g. kaolin) is obtained from naturally occurring sources, it may be that some mineral impurities will inevitably contaminate the ground material. For example, naturally occurring kaolin may occur in association with other minerals such as dolomite. Also, in some circumstances, minor additions of other minerals may be included, for example, one or more of dolomite, talc, wollastonite, bauxite, or mica, could also be present. In general, however, the minerals used in the mineral blend will each comprise less than 5% by weight, for example less than 2 wt %, for example less than 1% by weight of other minerals.

In some embodiments, the particulate minerals each independently undergo minimal processing following mining or extraction. In a further embodiment, the particulate mineral is subjected to at least one physical modification process. The skilled artisan will readily know physical modification processes appropriate for use, which may be now known or hereafter discovered; appropriate physical modification processes include, but are not limited to, comminution (e.g. crushing, grinding, milling), drying, and classifying (e.g. air classification, hydrodynamic selection, screening and/or sieving). In yet other embodiments, the particulate minerals are each independently subjected to at least one chemical modification process. The skilled artisan will readily know chemical modification processes appropriate for use in the present compounds and processes, which may be now known or hereafter discovered; appropriate chemical modification processes include but are not limited to, silanization and calcination. The particulate kaolin material may, for example, be surface treated or surface untreated. The surface treatment may, for example, serve to modify a property of the kaolin particulate and/or the composition into which it is incorporated. In one embodiment the surface treatment is by an aminosilane, including but not limited to APTES-gamma-aminopropyltriethoxysilane, APDEMS-(3-aminopropyl)-diethoxy-methylsilane, APDMES-(3-aminopropyl)-dimethyl-ethoxysilane, APTMS-(3-aminopropyl)-trimethoxysilane.

In certain embodiments, the surface treatment of the kaolin is present in an amount up to about 5 wt %, based on the total weight of particulate mineral, for example, from about 0.001 wt % to about 5 wt %, or from about 0.01 wt % to about 2 wt %, or from about 0.1 wt % to about 2 wt %, or from about 0.5 wt % to about 1.5 wt %, based on the total weight of particulate mineral. In certain embodiments, the particulate mineral is not surface treated.

In one embodiment, the mineral blend may have a median particle size (d₅₀) in a range of 0.5-3 μm, or 0.8-2.3 μm, or 0.9-1.9 μm, or 0.9-1.6 μm, or or 0.9-1.5 μm. In one embodiment, the median particle size is no larger than 2.3 μm. In some embodiments, the mineral blend may be pelletized and milled in order to obtain certain particle sizes. In one embodiment, the mineral blend may have a residual moisture content of 3 wt % or less, or 2 wt % or less, or 1 wt % or less, or 0.7 wt % or less, or 0.1 wt % or less, relative to a total weight of the mineral blend. In one embodiment, the mineral blend may have an oil absorption of 30 g/100 g or less, or 20 g/100 g or less, or 15 g/100 g or less, or 10 g/100 g or less or 5 g/100 g or less. The oil absorption may be measured with linseed oil or some other oil. These properties described above and below may be for the mineral blend with or without a hydrophobic coating or other surface treatment.

As used herein, “BET surface area” refers to the area of the surface of the particles of the particulate talc material with respect to unit mass, determined according to the BET method by the quantity of nitrogen adsorbed on the surface of said particles so as to form a monomolecular layer completely covering said surface (measurement according to the BET method, AFNOR standard X11-621 and 622 or ISO 9277). In certain embodiments, BET surface area is determined in accordance with ISO 9277 or any method equivalent thereto. In one embodiment, the mineral blend may have a surface area of 0.1-15 m²/g, or 1-12 m²/g, or 2-10 m²/g, or 3-8 m²/g. In one embodiment, the mineral blend may have a surface area of no greater than 9 m²/g.

In one embodiment, mixing the mineral blend in water may produce an aqueous mixture having a conductivity in a range of 0-200 μS/cm, or 20-180 μS/cm, or 40-170 μS/cm, or 50-150 μS/cm. In one embodiment, the conductivity may be no more than 170 μS/cm. Here, the mineral blend may be present in the aqueous mixture at a weight percentage in a range of 0.1-75 wt %, 1-40 wt %, 2-30 wt %, relative to a total weight of the aqueous mixture, and the aqueous mixture may have a temperature in a range of 20-32° C. In one embodiment, the mineral blend may have an ignition loss at 800° C. that is in a range of 1-35 wt %, 2-30 wt %, 3-20 wt %, or 4-10 wt %. In one embodiment, the mineral blend may have an ignition loss at 800° C. that is no greater than 29 wt %. In one embodiment, the mineral blend may have a bulk density in a range of 0.50-1.20 g/cm³, or 0.55-1.10 g/cm³, or 0.60-1.00 g/cm³, or 0.65-0.85 g/cm³.

In one embodiment, the polymer is present in the flame resistant polymer composition at a weight percent in a range of 20-80 wt %, or 25-70 wt %, or 30-60 wt %, or 35-50 wt %, relative to a total weight of the flame retardant polymer composition. In one embodiment, the polymer is present in the form of a polymer matrix.

In one embodiment, the polymer is a polyolefin. Polyolefins are polymers of relatively simple olefins such as ethylene, propylene, butene(s), isoprene(s), and pentene(s), and include copolymers and modifications as disclosed in Whittington's Dictionary of Plastics, p. 252 (Technomic Publications, 1978).

In one embodiment, the polymer is an elastomer. An “elastomer” is a rubber-like polymer which can be stretched under tension to at least twice its original length and retracts rapidly to its original dimensions when the tensile force is released. An elastomer generally has an elastic modulus less than about 6,000 psi and an elongation generally greater than 200% in the uncrosslinked state at room temperature in accordance with the method of ASTM D412.

In one embodiment, the polymer is an elastomer selected from the group consisting of alkyl acrylate copolymer (acrylic rubber), ethylene propylene diene monomer rubber (EPDM rubber), In one embodiment the surface treatment is by an aminosilane, including but not limited to APTES-gamma-aminopropyltriethoxysilane, APDEMS-(3-aminopropyl)-diethoxy-methylsilane, APDMES-(3-aminopropyl)-dimethyl-ethoxysilane, APTMS-(3-aminopropyl)-trimethoxysilane. fluoroelastomer, polybutadiene, polyisobutylene (PIB), polyisoprene, silicone rubber, and natural rubber.

In one embodiment, the polymer is a thermoplastic polymer. A “thermoplastic” material is a linear or branched polymer which can be repeatedly softened and made flowable when heated and then returned to a hard state when cooled to room temperature. It generally has an elastic modulus greater than 10,000 psi in accordance with the method of ASTM D638. In addition, thermoplastics can be molded or extruded into articles of any predetermined shape when heated to the softened state. In some embodiments, a polymer may be considered both an elastomer and a thermoplastic.

In one embodiment, the polymer is a thermoplastic polymer selected from the group consisting of acrylic, acrylonitrile butadiene styrene, ethylene-vinyl acetate (EVA), nylon (polyamides), poly(vinyl acetate), polyacrylonitrile, polybenzimidazole, polybenzoxazole, polybenzthiazole, polybutene-1(PB-1), polybutylene, polycarbonate, polyether sulfone, polyetherether ketone, polyetherimide, polyethylene, polyethylene adipate (PEA), polyethylene terephthalate (PET or PETE), polyimide, polylactic acid (PLA), polymethyl acrylate, polymethyl methacrylate, polymethylpentene (PMP), polyoxymethylene (acetal), polyphenylene oxide, polyphenylene sulfide, polypropylene, polystyrene, polytetrafluoroethylene, polyvinyl alcohol, polyvinyl chloride, polyvinyl ester (general formula —[RCOOCHCH₂]—), and polyvinylidene fluoride.

In a preferred embodiment, the polymer is a thermoplastic polymer and is ethylene-vinyl acetate, polyethylene, or a blend of both. In a further embodiment, the polymer is a blend of both ethylene-vinyl acetate and polyethylene. The ethylene-vinyl acetate may be present in the blend at a weight percentage of 1-99 wt %, or 10-90 wt %, 20-80 wt %, 30-70 wt %, or 40-60 wt % relative to a total weight of the polymer. Likewise, polyethylene may be present in the blend at a weight percentage of 1-99 wt %, preferably 10-90 wt %, 20-80 wt %, 30-70 wt %, or 40-60 wt % relative to a total weight of the polymer. In one embodiment, the ethylene-vinyl acetate is Braskem HM728®. In one embodiment the polyethylene is Braskem LH218®.

Ethylene-vinyl acetate, is an elastomeric polymer that produces materials which are “rubber-like” in softness and flexibility. The material has good clarity and gloss, low-temperature toughness, stress-crack resistance, hot-melt adhesive waterproof properties, and resistance to UV radiation. Ethylene-vinyl acetate is also known as poly (ethylene-vinyl acetate) (PEVA), is the copolymer of ethylene and vinyl acetate. The weight percent vinyl acetate typically varies from 10 to 40%, with the remainder being ethylene. Ethylene-vinyl acetate may be classified into three groups based on the vinyl acetate content.

Ethylene-vinyl acetate having a low proportion of vinyl acetate (approximately up to 4 wt %) may be referred to as vinyl acetate modified polyethylene. It is a copolymer and is processed as a thermoplastics material, similar to low density polyethylene. It has some of the properties of a low density polyethylene but increased gloss, softness and flexibility.

Ethylene-vinyl acetate having a moderate proportion of vinyl acetate (4-30 wt %) is referred to as thermoplastic ethylene-vinyl acetate copolymer, and is a thermoplastic elastomer material. It is not vulcanized but has some of the properties of a rubber or of plasticized polyvinyl chloride, particularly with higher amounts of vinyl acetate. Ethylene-vinyl acetates with 9-13 wt % vinyl acetate may be used as hot melt adhesives.

Ethylene-vinyl acetate having higher concentrations of vinyl acetate (for instance, greater than 40 wt %) may be referred to as ethylene-vinyl acetate rubber.

Polyethylene (PE) is a common type of plastic, with most having the chemical formula (C₂H₄)ₙ, and with different degrees of branching. PE is usually a mixture of similar polymers of ethylene with various values of n. Polyethylene is a thermoplastic; however, it can become a thermoset plastic when modified (such as cross-linked polyethylene). The individual macromolecules are not covalently linked. Because of their symmetric molecular structure, they tend to crystallize; overall polyethylene is partially crystalline. Higher crystallinity increases density and mechanical and chemical stability.

Polyethylene may be classified by its density and branching. Its mechanical properties depend significantly on variables such as the extent and type of branching, crystal structure, and molecular weight. Types of polyethylene include but are not limited to ultra-high-molecular-weight polyethylene (UHMWPE), ultra-low-molecular-weight polyethylene (ULMWPE or PE-WAX), high-molecular-weight polyethylene (HMWPE), high-density polyethylene (HDPE), high-density cross-linked polyethylene (HDXLPE), cross-linked polyethylene (PEX or XLPE), medium-density polyethylene (MDPE), linear low-density polyethylene (LLDPE), low-density polyethylene (LDPE), very-low-density polyethylene (VLDPE), and chlorinated polyethylene (CPE).

In a further embodiment, the polyethylene is linear low-density polyethylene (LLDPE). Linear low-density polyethylene is a substantially linear polyethylene, with significant numbers of short branches, commonly made by copolymerization of ethylene with longer-chain olefins. LLDPE may be defined by a density range of 0.915-0.925 g/cm³. Linear low-density polyethylene differs structurally from conventional low-density polyethylene (LDPE) because of the absence of long chain branching. The linearity of LLDPE results from the different manufacturing processes of LLDPE and LDPE. In general, LLDPE is produced at lower temperatures and pressures by copolymerization of ethylene and such higher alpha-olefins as butene, hexene, or octene. The copolymerization process produces an LLDPE polymer that has a narrower molecular weight distribution than conventional LDPE and in combination with the linear structure, and significantly different rheological properties.

In one embodiment, the polyethylene may be an olefin-based block copolymer containing a polymer block composed of ethylene and an ethylene α-olefin copolymer block. Here, the polyethylene may be mainly composed of ethylene, with the remainder of the structure being a different monomer unit. The other monomer unit includes, for example, 1-propylene, 1-butene, 2-methylpropylene, 1-pentene, 3-methyl-1-butene, 1-hexene, 4-methyl-1-pentene, and 1-octene. An α-olefin having a carbon-carbon double bond at a terminal carbon atom and having a carbon number of 3 to 8, such as 1-propylene, 1-butene, 1-hexene, and 1-octene, is preferred.

In one embodiment, the flame retardant polymer composition further comprises less than 5 wt %, or less than 4 wt % aluminum hydroxide, or less than 3 wt %, or less than 2 wt %, or less than 1 wt %, or less than 0.1 wt %, relative to a total weight of the flame retardant polymer composition. In one embodiment, the flame resistant polymer composition may be essentially free of aluminum hydroxide, meaning that the flame resistant polymer composition comprises less than 0.01 wt % aluminum hydroxide, or less than 0.001 wt % aluminum hydroxide, or 0 wt % aluminum hydroxide, relative to a total weight of the flame retardant polymer composition. Aluminum hydroxide may be referred to as ATH. The aluminium hydroxide may, for example, be gibbsite, bayerite, nordstrandite, doyleite, or a combination of one or more thereof.

In one embodiment, the flame retardant polymer composition is essentially free of halogens, meaning that the flame resistant polymer composition comprises less than 0.01 wt % halogens, or less than 0.001 wt % halogens, or 0 wt % halogens, relative to a total weight of the flame retardant polymer composition. In one embodiment, the flame resistant polymer composition does not comprise carbon black, diatomaceous earth, xylene, and/or zinc oxide.

The halogen may be an organohalogen compound. The organohalogen compound may, for example, be an organochloride (e.g. chlorendic acid derivatives, chlorinated paraffin), an organobromide (e.g. decabromodiphenyl ether, decabromodiphenyl ethane, brominated polystyrenes, brominated carbonate oligomers, brominated epoxy oligomers, tetrabromophthalic anhydride, tetrabromobisphenol A, hexabromocyclododecane), a halogenated organophosphate (e.g. tris(1,3-dichloro-2-propyl)phosphate, tetrakis(2-chlorethyl)dichloroisoentyldiphosphate), or a combination of one or more thereof.

In one embodiment, the flame resistant polymer composition is essentially free of phosphorous and nitrogen containing compounds meaning that the flame resistant polymer composition comprises less than 0.01 wt % of these compounds in total, or less than 0.001 wt %, or 0 wt %, relative to a total weight of the flame retardant polymer composition. The phosphorous and/or nitrogen-containing compound may, for example, be red phosphorous, a phosphate, a polyphosphate (e.g. melamine polyphosphate), an organophosphate (e.g. triphenyl phosphate (TPP), resorcinol bis(diphenylphosphate) (RDP), bisphenol A diphenyl phosphate (BADP), tricresyl phosphate (TCP)), a phosphonate (e.g. dimethyl methylphosphonate (DMMP), a phosphinate (e.g. aluminium diethyl phosphinate), a halogenated organophosphate (e.g. tris(1,3-dichloro-2-propyl)phosphate, tetrakis(2-chlorethyl)dichloroisoentyldiphosphate), a phosphazene, a polyphosphazene, a triazine or a combination of one or more thereof.

In one embodiment, the flame retardant polymer composition further comprises titanium dioxide. In one embodiment, the titanium dioxide may be Tiona RKB2®. The titanium dioxide may be present at a weight ratio in range of 0.01-2.00 wt %, or 0.1-1.00 wt %, or 0.40-0.80 wt %, relative to a total weight of the flame resistant polymer composition. In one embodiment, the titanium dioxide may be used as a pigment. However, other inorganic pigments or organic dyes may be used in addition to or in place of the titanium dioxide. Other inorganic pigments include but are not limited to barium sulfate, antimony(III) oxide, lithopone, zinc oxide, manganese dioxide, iron oxide, and malachite. Organic dyes include but are not limited to azo dye, carmine, naphthol red, and indigo. In one embodiment, other dyes, pigments, or coloring agents appropriate for polymer compounds may be used.

In one embodiment, the flame resistant polymer composition consists of kaolin (surface treated or untreated as described above), an alkaline earth carbonate, magnesium hydroxide, and polymer. In one embodiment, the flame resistant polymer composition consists of kaolin (surface treated or untreated), an alkaline earth carbonate, magnesium hydroxide, polymer, and titanium dioxide.

In one embodiment, the flame retardant polymer composition further comprises 0.01-5 wt %, or 0.1-3 wt %, or 0.5-2 wt %, or 0.6-1.6 wt % of a fatty acid, a polysiloxane, or both, each relative to a total weight of the flame retardant polymer composition. In one embodiment, a total weight percentage of the fatty acid and/or polysiloxane does not exceed more than 1.6 wt %. The fatty acid, siloxane, or both may be added to the mineral blend to form a hydrophobic coating on the mineral blend. In accordance with one embodiment, the kaolin used in the mineral blend coated with the hydrophobic coating is not treated with an aminosilane. In another embodiment, the mineral blend including surface treated kaolin (such as treated with an aminosilane) is not coated with the hydrophobic coating. In one embodiment, the fatty acid may be a saturated fatty acid including but not limited to butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, hentriacontylic acid, lacceroic acid, psyllic acid, geddic acid, ceroplastic acid, hexatriacontylic acid, heptatriacontanoic acid, octatriacontanoic acid, nonatriacontanoic acid, and/or tetracontanoic acid. In other embodiments, an unsaturated fatty acid may be used as the fatty acid, or may be used in combination with a saturated fatty acid. In other embodiments, rather than a fatty acid, some other lipid may be used that comprises saturated lipid tails, including but not limited to lipids classified as glycerolipids, glycerophospholipids, sphingolipids, triglycerides, sterol lipids, prenol lipids, and saccharolipids. In other embodiments, rather than a fatty acid or other lipid, a waxy or oily compound may be used, for instance, petroleum distillates, petroleum jelly, paraffin, asphaltenes, or wax.

In one embodiment, the polysiloxane may be polydimethylsiloxane (PDMS), polymethylhydrosiloxane (PMHS), tetrakis(trimethylsilyloxy)silane (TTMS), 2,6-cisdiphenylhexamethylcyclotetrasiloxane (“Quadrosilan”). In another embodiment, the polysiloxane may comprise monomer units of hexamethylcyclotrisiloxane, octamethylcyclotetrasiloxane, decamethylcyclopentasiloxane, methylsiloxane, ethylsiloxane, propylsiloxane, pentylsiloxane, dodecamethylcyclohexasiloxane, hexamethyldisiloxane, octamethyltrisiloxane, decamethyltetrasiloxane, dodecamethylpentasiloxane, tetradecamethylhexasiloxane, silicone resin, silicone grease, silicone rubber, and/or silicone oil. The polysiloxane may have a room temperature viscosity in a range of 300-400 cP, or 320-380 cP, or about 350 cP. In one embodiment, rather than a polysiloxane, the mineral blend may be silanized, for instance, by reacting with APTES (3-aminopropyl)-triethoxysilane, APDEMS (3-aminopropyl)-diethoxy-methylsilane, APDMES (3-aminopropyl)-dimethyl-ethoxysilane, APTMS (3-aminopropyl)-trimethoxysilane, GPMES (3-glycidoxypropyl)-dimethyl-ethoxysilane, MPTMS (3-mercaptopropyl)-trimethoxysilane, MPDMS (3-mercaptopropyl)-methyl-dimethoxysilane, or some other silane. However, in some embodiments, the mineral blend may be silanized, and then additionally coated with a polysiloxane and/or a fatty acid.

In a further embodiment, the fatty acid is stearin (or steric acid) and the polysiloxane is PDMS. In a further embodiment, the flame retardant polymer composition comprises both fatty acid and polysiloxane at a weight ratio in a range of 1:1-6:1 stearin to polysiloxane, preferably 2:1-5.5:1, or 3:1-5:1, or at least 3:1.

In one embodiment, the mineral blend may be mixed with the fatty acid and/or polysiloxane in a V-type inversion mixer and homogenized for 10-60 minutes, or 15-40 minutes, or about 20 minutes. In one embodiment, mixing the mineral blend with the fatty acid and/or the polysiloxane may cause particles of the mineral blend to agglomerate and stick to each other. However, in some embodiments, the particles may stay separated.

In one embodiment, the flame resistant polymer composition consists of polymer, kaolin, an alkaline earth carbonate, magnesium hydroxide, fatty acid, and polysiloxane. In one embodiment, the flame resistant polymer composition consists of polymer, kaolin, an alkaline earth carbonate, magnesium hydroxide, fatty acid, polysiloxane, and titanium dioxide.

In one embodiment, the fatty acid and/or polysiloxane is added or coated onto the surface of particles of mineral blend, before being melt-mixed into the polymer matrix. The fatty acid and/or polysiloxane may confer hydrophobicity to the mineral blend particles, which may enable them to mix and disperse more readily into the polymer matrix. In one embodiment a commercial formulation such as Iragnox 1010® may be added to the mineral blend.

In one embodiment, the mineral blend may be in the form of particles or granules having a spherical or substantially spherical shape (i.e., where the sides are rounded or well-rounded) with a sponge-like (i.e., porous) appearance. As defined here, having a substantially spherical shape means that the distance from the particle centroid (center of mass) to anywhere on the particle outer surface varies by less than 30%, or by less than 20%, or by less than 10% of the average distance.

In some embodiments, a portion of the particles or granules of the mineral blend may be angular (corners sharp and jagged), sub-angular, or sub-rounded and possess a jagged flake-like morphology. In one embodiment, the mineral blend may comprise a high aspect ratio particular material. The term “high aspect ratio particulate mineral” refers to a mineral having particles that are acicular or lamellar. Lamellar particles generally have a small, flat and flaky or platy appearance. Acicular particles generally have a long, thin fiber or needle-like appearance.

In one embodiment, the particles or granules of the mineral blend are monodisperse, having a coefficient of variation or relative standard deviation, expressed as a percentage and defined as the ratio of the particle diameter standard deviation (σ) to the particle diameter mean (μ), multiplied by 100%, of less than 25%, or less than 10%, or less than 8%, or less than 6%, or less than 5%. In one embodiment, the particles are monodisperse, having a particle diameter distribution ranging from 80% of the average particle diameter to 120% of the average particle diameter, or 85-115%. In another embodiment, the particles are not monodisperse, for instance, they may be considered polydisperse. Here, the coefficient of variation may be greater than 25%, or greater than 37%. In one embodiment, the particles or granules are polydisperse with a particle diameter distribution ranging from 70% of the average particle diameter to 130% of the average particle diameter, or ranging from 60-140%, or 50-150%. In one embodiment, the mineral blend may not change noticeably in morphology when being mixed into the polymer. In other embodiments, the mineral blend may break apart and form smaller particles when being mixed into the polymer.

In one embodiment, the flame retardant polymer composition further comprises 0.01-0.05 wt %, or 0.02-0.04 wt %, dicumyl peroxide (DCP), relative to a total weight of the flame retardant polymer composition. In another embodiment, the flame retardant polymer composition comprises 0.001-0.50 wt %, 0.005-0.20 wt %, 0.01-0.10 wt %, or 0.02-0.08 wt % dicumyl peroxide. In one embodiment, the flame resistant polymer composition comprises about 0.03 wt % dicumyl peroxide. In other embodiments, the flame resistant polymer composition may comprise some other organic peroxide instead of, or in addition to, the dicumyl peroxide. For instance, the flame resistant polymer composition may comprise an organic peroxide including but not limited to acetone peroxide, acetozone, an alkenyl peroxide, arachidonic acid 5-hydroperoxide, artelinic acid, benzoyl peroxide, α,α-bis(tbutylperoxy)diisopropyl benzene, bis(trimethylsilyl) peroxide, tert-butyl hydroperoxide, tert-butyl peroxybenzoate, cumene hydroperoxide, di-tert-butyl peroxide, diacetyl peroxide, diethyl ether peroxide, dihydroartemisinin, dimethyldioxirane, 1,2-dioxane, 1,2-dioxetane, 1,2-dioxetanedione, dioxirane, dipropyl peroxydicarbonate, ergosterol peroxide, hexamethylene triperoxide diamine, methyl ethyl ketone peroxide, paramenthane hydroperoxide, a peroxyacetyl nitrate, and/or 1,2,4-trioxane.

In one embodiment, the flame resistant polymer composition consists of polymer, kaolin, an alkaline earth carbonate, magnesium hydroxide, fatty acid, polysiloxane, and dicumyl peroxide. In one embodiment, the flame resistant polymer composition consists of polymer, kaolin, an alkaline earth carbonate, magnesium hydroxide, fatty acid, polysiloxane, dicumyl peroxide, and titanium dioxide.

In one embodiment, the flame resistant polymer composition may comprise other additives, including but not limited to other polymeric or elastomeric materials, silica, perlite, talc, diatomaceous earth, zinc oxide, sodium bicarbonate, gypsum, calcium silicate, sodium silicate, potassium silicate, magnesium oxide, glass, feldspar, cement, lignosulfonate, magnesium nitrate, calcium oxide, bentonite, melamine, poly[(hydroxyphenylene)methylene], carbon fiber, spinel oxide, clay, belite (2CaO.SiO₂), alite (3CaO.SiO₂), celite (3CaO.Al₂O₃), or brownmillerite (4CaO.Al₂O₃.Fe₂O₃), mica, other carbonates, other ceramic fillers, carbon black, fibers, fiberglass, metal hydrates, borates, red phosphorous, other oxides, reinforcers, UV stabilizers, light stabilizers, release agents, processing aids, nucleating agents, pigments, coupling agents (e.g. maleic anhydride grafted polyolefins), compatibilizers (e.g. maleic anhydride grafted polyolefins), opacifying agents, pigments, colorants, slip agents (for example Erucamide), antioxidants, anti-fog agents, anti-static agents, anti-block agents, moisture barrier additives, gas barrier additives, dispersants, hydrocarbon waxes, stabilizers, co-stabilizers, lubricants, agents to improve tenacity, agents to improve heat-and-form stability, agents to improve processing performance, process aids (for example Polybatch® AMF-705), mould release agents (e.g. fatty acids, zinc, calcium, magnesium, lithium salts of fatty acids, organic phosphate esters, stearic acid, zinc stearate, silicone rubber, calcium stearate, magnesium stearate, lithium stearate, calcium oleate, zinc palmitate), antioxidants, and plasticizers. The flame resistant polymer composition may comprise commercial additives such as Polybond 3200®, Bluesil MF 175®, Irganox 1010®, Irganox 168®, and/or Irganox B215®. The flame resistant polymer composition may comprise one or more additive at a weight percentage of 0.1-10 wt %, or 0.2-5 wt %, or 0.5-1 wt %, relative to a total weight of the flame resistant polymer composition. In one embodiment, any of the above additives mentioned may not be present in the flame resistant polymer composition.

In one embodiment, the flame retardant polymer composition has a density in a range of 1.1-1.8 g/cm³, 1.2-1.7 g/cm³, 1.3-1.6 g/cm³, or 1.4-1.5 g/cm³. In one embodiment, the flame retardant polymer composition has a melt flow rate in a range of 2.0-4.5 cm³/10 min, 2.2-4.2 cm³/10 min, or 2.8-4.0 cm³/10 min at 150° C. according to ASTM D 1238-10. In one embodiment, the flame retardant polymer composition has a melt flow rate in a range of 47-70 cm³/10 min, 49-67 cm³/10 min, 52-65 cm³/10 min, or 55-62 cm³/10 min at 230° C. according to ASTM D 1238-10.

In one embodiment, the flame retardant polymer composition has a tensile strength at break in a range of 6-10 MPa, or 6.5-9.5 MPa, or 7.0-9.0 MPa according to ASTM D 638-14. In one embodiment, the flame retardant polymer composition has a tensile strain at break in a range of 15-40%, 17-40%, 19-38%, 21-36%, or 23-35%, according to ASTM D 638-14.

The term “flame retardant” refers to any chemical that, when added to a polymer, can prevent fire, inhibit, or delay the spread of fire and/or limit the damage caused by fire. Flame retardants are activated by the presence of an ignition source and are intended to prevent or slow the further development of ignition by a variety of different physical and chemical methods. The flame retardant may work by one or more of endothermic degradation, thermal shielding, dilution of gas phase and gas phase radical quenching. Flame retardants that work by endothermic degradation remove heat from the substrate and thus cool the material. Flame retardants that work by thermal shielding create a thermal insulation barrier between the burning and unburned parts of the material, for example by forming a char, which separates the flame from the material and slows heat transfer to the unburned material. Flame retardants may work by dilution of the gas phase produce inert gases (e.g. carbon dioxide and/or water) by thermal degradation and thus dilute the combustible gases, thus lowering the partial pressures of the combustible gases and oxygen and slowing the reaction rate. In certain embodiments, the flame retardant used in the flame-retardant polymer compositions disclosed herein work by endothermic degradation and/or dilution of the gas phase. In one embodiment, the alkaline earth carbonate and/or magnesium hydroxide of the mineral blend reacts endothermically during combustion of the polymer below 600° C.

In one embodiment, the mineral blend may be considered intumescent, which means that it swells as a result of heat exposure, thus increasing in volume and decreasing in density. Preferably this decrease in density limits any subsequent heat transfer. The intumescent property of the mineral blend may be one characteristic that confers flame retardant behavior to the flame resistant polymer composition and may enable it to be used as a material for passive fire protection. In one embodiment, the flame retardant polymer composition has a UL94 flammability rating of V-0 and/or V-1. In one embodiment, the flame resistant polymer composition having dicumyl peroxide may be more resistant against a flame than a similar flame resistant polymer composition that does not contain dicumyl peroxide.

According to a second aspect, the present disclosure relates to an insulated wire product, comprising an electrically-conductive wire coated with a layer of the flame retardant polymer composition of the first aspect. An “electrically-conductive wire” as defined here is a substance with an electrical resistivity of at most 10⁻⁶ Ω·m, or at most 10⁻⁷ Ω·m, or at most 10⁻⁸ Ω·m at a temperature of 20-25° C. The electrically-conductive wire may comprise platinum-iridium alloy, iridium, titanium, titanium alloy, stainless steel, gold, cobalt alloy, copper, aluminum, tin, iron, and/or some other metal.

The thickness of the flame retardant polymer composition covering the wire may, for example, be equal to or less than about 1 mm. For example, the thickness of the flame retardant polymer composition may be equal to or less than about 0.9 mm or equal to or less than about 0.8 mm or equal to or less than about 0.7 mm or equal to or less than about 0.6 mm. The thickness of the flame retardant polymer composition covering the wire may, for example, be at least about 0.1 mm or at least about 0.2 mm. The wire may have a diameter in a range of 0.01 mm-3 cm, 0.1 mm-2 cm, 1.0 mm-1 cm, or 2.0 mm-5.0 mm.

According to a third aspect, the present disclosure relates to a method of making the flame retardant polymer composition of the first aspect. This method involves melt-mixing polysiloxane or fatty acid coated mineral blend with the polymer.

In one embodiment of the method, the polysiloxane or fatty acid coated mineral blend is present as particles with a mean diameter in a range of 0.5-10 μm, 0.8-9 μm, 1-8 μm, or 2-7 μm. In one embodiment of the method, the polysiloxane or fatty acid coated mineral blend has a BET surface area in a range of 2-20 m²/g, 4-17 m²/g, 6-15 m²/g, or 8-13 m²/g.

In one embodiment of the method, the melt-mixing is done in a single or twin screw extruder having an RPM in a range of 100-300, 120-280, or 140-260 and heated with a temperature gradient having a maximum temperature in a range of 150-250° C., or 160-240° C., and a lowest temperature in a range of 25-70° C., or 28-40° C., or about 30° C. In one embodiment, the RPM may be about 150 or about 250. In one embodiment, the maximum temperature may be about 170° C. or about 239° C. The total length of the screw extruder may be 0.5-3 m, or 0.8-2 m.

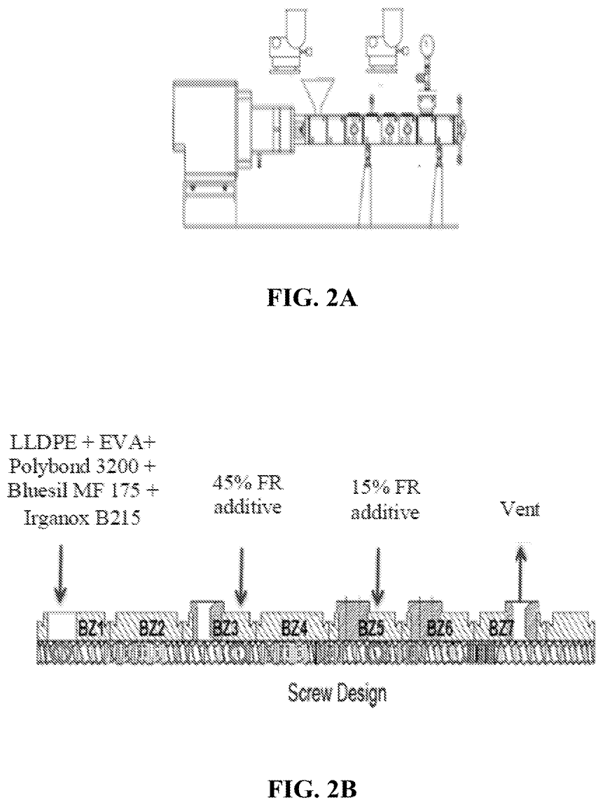

In one embodiment of the method, the melt-mixing involves first melt-mixing the polymer in a heated screw extruder and then adding the mineral blend (with or without fatty acid and polysiloxane coating) to the heated screw extruder. In a further embodiment, the mineral blend may be added in two portions and at two different locations along the screw extruder, as indicated in FIG. 2B. Preferably the mineral blend is added through a hopper attached to a hammer mill, and a mixture productivity of the hammer mill may be 500-900 kg/h or about 800 kg/h. In one embodiment, the feeder throughput of the mineral blend may be in a range of 5-25 kg/h, or 7-20 kg/h, or about 9-12 kg/h. In one embodiment, the flame resistant polymer composition may be produced at a rate of 1-2,000 kg/h, 10-1,000 kg/h, or 20-100 kg/h using a single extruder with one or two screws.

The flame resistant polymer composition may be made by compounding the polymer with the mineral blend and any optional additives. Compounding is a technique which is well known to persons skilled in the art of polymer processing and manufacture and consists of preparing plastic formulations by mixing and/or blending polymers and optional additives in a molten state. It is understood in the art that compounding is distinct from blending or mixing processes conducted at temperatures below that at which the constituents become molten. Compounding may, for example, be used to form a masterbatch composition. Compounding may, for example, involve adding a masterbatch composition to a polymer to form a further polymer composition.

The flame retardant polymer composition described herein may, for example, be extruded. For example, compounding may be carried out using a screw, e.g. a twin screw, compounder, for example, a Baker Perkins 25 mm twin screw compounder. For example, compounding may be carried out using a multi roll mill, for example a two-roll mill. For example, compounding may be carried out using a co-kneader or internal mixer. The methods disclosed herein may, for example, include compression moulding or injection moulding. The polymer and/or mineral blend and/or optional additives may be premixed and fed from one or more hoppers. In one embodiment, grafted maleic anhydride polypropylene, Irganox B215 (Irganox 1010/Irgafos 168), and silicone rubber sheets are added as additives, and the silicone rubber sheets may be impregnated with the mineral blend.

In one embodiment, the molten flame resistant polymer composition being extruded may be in the form of pellets or strands. These may be cooled, for example in a water bath, and then pelletized. After pelletizing, the flame resistant polymer composition may be dried at 50-80° C., or 70° C. for 6-24 h, or 12 h. The dried flame resistant polymer composition pellets may be calendared to form a sheet or film, or subjected to other molding or injecting processes as described herein.

The flame retardant polymer compositions described herein may, for example, be shaped into a desired form or article. Shaping of the flame retardant polymer compositions may, for example, involve heating the composition to soften it. The polymer compositions described herein may, for example, be shaped by molding (e.g. compression molding, injection molding, stretch blow molding, injection blow molding, overmolding), extrusion, casting, or themoforming.

The flame resistant polymer composition may be injection molded, blow molded, compression molded, low pressure injection molded, extruded and then thermoformed by either male or female vacuum thermoforming, injection compression-molding, injection-foaming, injection hollow molding, compression-molding or prepared by a hybrid process such as low pressure molding wherein a blanket of still-molten flame resistant polymer composition is placed against the back of a skin foam composite and pressed under low pressure to form the skin and bond it to a hard substrate. For injection molding, the molding temperature may be in the range of about 150 to about 350° C., or about 170 to about 320° C.; the injection pressure is in the range of usually about 5 to about 100 MPa, or about 10 to about 80 MPa; and the mold temperature is in the range of usually about 20 to about 80° C., or about 20 to about 60° C. In other embodiments, flame resistant polymer composition may be formed by other manufacturing methods, such as casting, forming, machining, or joining of two or more pieces.

In one embodiment, following the injection molding or forming of the flame resistant polymer composition, a surface treatment method may be applied, including but not limited to, priming, solvent etching, sulfuric or chromic acid etching, sodium treatment, ozone treatment, flame treatment, UV irradiation, and plasma treatment.

According to a fourth aspect, the present disclosure relates to a method of forming a flame retardant object. The method involves heating the flame retardant polymer composition of the first aspect to form a molten composition. Then a surface of an object is contacted with the molten composition to form a flame retardant object. Alternatively, the molten flame resistant polymer composition coming from the extruder during the melt-mixing to form the flame resistant polymer composition may be contacted with the object, without being cooled and pelletized. As used herein, the surface being contacted with the molten composition is considered to be equivalent to the molten composition being contacted with the surface.

In one embodiment of the method, the flame retardant object is an electrical conductor, an automotive part, a building material, an electronic device, or an electrical appliance. The flame retardant object may be a side wall, a door seal, an instrument panel, a part of a ship or airplane interior, a part of a furniture, a wall mounting, an insulation, an appliance or electronic device casing, an electrical insulator, a door, a piping, a firestop, a cushion, a cable sheath, or some other object.

According to a fifth aspect, the present disclosure relates to a method of forming a flame retardant object. The method involves injection molding the flame retardant polymer composition of the first aspect to form a flame retardant object. As mentioned before, in some embodiments, it may be possible to do the injection molding directly from the polymer and mineral blend being melt-mixed.

In one embodiment of the method the flame retardant object may be any of the objects as previously listed. In other embodiments, the object may be an elastomeric seal, an elastomeric bearing, a flexible sheet, for example for waterproofing and/or thermal insulation.

The following are exemplary embodiments of the present disclosure:

Embodiment 1: A flame retardant polymer composition, comprising:
a mineral blend comprising:
   kaolin;
   an alkaline earth carbonate; and
   magnesium hydroxide; and
a polymer,
wherein the mineral blend is present at a weight percent in a range of 20-80 wt %, and
wherein the polymer is present at a weight percent in a range of 20-80 wt %, each relative to a total weight of the flame retardant polymer composition.

Embodiment 2: The flame retardant polymer composition of Embodiment 1, wherein the mineral blend comprises
10-50 wt % kaolin;
10-50 wt % alkaline earth carbonate; and
10-50 wt % magnesium hydroxide, each relative to a total weight of the mineral blend.

Embodiment 3: The flame retardant polymer composition of Embodiment 1 or 2, wherein the mineral blend is dispersed in the polymer.

Embodiment 4: The flame retardant polymer composition of any one of Embodiments 1 to 3, wherein the kaolin is natural kaolin.

Embodiment 5: The flame retardant polymer composition of any one of Embodiments 1 to 4, wherein the alkaline earth carbonate is at least one selected from the group consisting of calcium carbonate, magnesium carbonate, dolomite, huntite, and magnesite.

Embodiment 6: The flame retardant polymer composition of any one of Embodiments 1 to 5, wherein the polymer is a polyolefin.

Embodiment 7: The flame retardant polymer composition of any one of Embodiments 1 to 6, wherein the polymer is an elastomer selected from the group consisting of acrylic rubber, ethylene propylene diene monomer rubber, ethylene propylene rubber, ethylene-vinyl acetate, fluoroelastomer, polybutadiene, polyisobutylene, polyisoprene, silicone rubber, and natural rubber.

Embodiment 8: The flame retardant polymer composition of any one of Embodiments 1 to 6, wherein the polymer is a thermoplastic polymer selected from the group consisting of acrylic, acrylonitrile butadiene styrene, ethylene-vinyl acetate, nylon, poly(vinyl acetate), polyacrylonitrile, polybenzimidazole, polybenzoxazole, polybenzthiazole, polybutene-1, polybutylene, polycarbonate, polyether sulfone, polyetherether ketone, polyetherimide, polyethylene, polyethylene adipate, polyethylene terephthalate, polyimide, polylactic acid, polymethyl acrylate, polymethyl methacrylate, polymethylpentene, polyoxymethylene, polyphenylene oxide, polyphenylene sulfide, polypropylene, polystyrene, polytetrafluoroethylene, polyvinyl alcohol, polyvinyl chloride, polyvinyl ester, and polyvinylidene fluoride.

Embodiment 9: The flame retardant polymer composition of Embodiment 8, wherein the thermoplastic polymer comprises ethylene-vinyl acetate and polyethylene.

Embodiment 10: The flame retardant polymer composition of Embodiment 9, wherein the polyethylene is linear low-density polyethylene.

Embodiment 11: The flame retardant polymer composition of any one of Embodiments 1 to 10, further comprising less than 5 wt % aluminum hydroxide relative to a total weight of the flame retardant polymer composition.

Embodiment 12: The flame retardant polymer composition of Embodiment 11, which comprises less than 0.1 wt % aluminum hydroxide relative to a total weight of the flame retardant polymer composition.

Embodiment 13: The flame retardant polymer composition of any one of Embodiments 1 to 12, which is essentially free of halogens.

Embodiment 14: The flame retardant polymer composition of any one of Embodiments 1 to 13, further comprising titanium dioxide.

Embodiment 15: The flame retardant polymer composition of any one of Embodiments 1 to 14, further comprising 0.01-5 wt % of a fatty acid, a polysiloxane, or both, each relative to a total weight of the flame retardant polymer composition.

Embodiment 15A: The flame retardant polymer composition of any one of Embodiments 1 to 14, wherein the kaolin is surface treated with a surface treatment, and the surface treatment is present in an amount up to about 5 wt %, based on the total weight of the kaolin (or particulate mineral).

Embodiment 16: The flame retardant polymer composition of Embodiment 15, wherein the fatty acid is stearin and the polysiloxane is PDMS.

Embodiment 17: The flame retardant polymer composition of Embodiment 15 or 16, comprising both fatty acid and polysiloxane at a weight ratio in a range of 1:1-6:1 stearin to polysiloxane.

Embodiment 18: The flame retardant polymer composition of any one of Embodiments 1 to 17, further comprising 0.01-0.05 wt % dicumyl peroxide, relative to a total weight of the flame retardant polymer composition.

Embodiment 19: The flame retardant polymer composition of any one of Embodiments 1 to 18, which has a density in a range of 1.1-1.8 g/cm3.

Embodiment 20: The flame retardant polymer composition of any one of Embodiments 1 to 19, which has a melt flow rate in a range of 2.0-4.5 cm3/10 min at 150° C. according to ASTM D 1238-10.

Embodiment 21: The flame retardant polymer composition of any one of Embodiments 1 to 20, which has a melt flow rate in a range of 47-70 cm3/10 min at 230° C. according to ASTM D 1238-10.

Embodiment 22: The flame retardant polymer composition of any one of Embodiments 1 to 21, which has a tensile strength at break in a range of 6-10 MPa according to ASTM D 638-14.

Embodiment 23: The flame retardant polymer composition of any one of Embodiments 1 to 22, which has a tensile strain at break in a range of 15-40% according to ASTM D 638-14.

Embodiment 24: The flame retardant polymer composition of any one of Embodiments 1 to 23, which has a UL94 flammability rating of V-0 or V-1.

Embodiment 25: An insulated wire product, comprising: an electrically-conductive wire coated with a layer of the flame retardant polymer composition of any one of Embodiments 1 to 24.

Embodiment 26: A method of making the flame retardant polymer composition of any one of Embodiments 1 to 15 and 16 to 24, the method comprising: melt-mixing polysiloxane or fatty acid coated mineral blend with the polymer.

Embodiment 26A: A method of making the flame retardant polymer composition of Embodiment 15A, the method comprising: melt-mixing polysiloxane or fatty acid coated mineral blend with the polymer.

Embodiment 27: The method of Embodiment 26, wherein the polysiloxane or fatty acid coated mineral blend has a mean diameter in a range of 0.5-10 μm.

Embodiment 28: The method of Embodiment 26 or 27, wherein the polysiloxane or fatty acid coated mineral blend has a BET surface area in a range of 2-20 m²/g.

Embodiment 29: The method of any one of Embodiments 26 to 28, wherein the melt-mixing is done in a screw extruder having an RPM in a range of 100-300 and heated with a temperature gradient having a maximum temperature in a range of 150-250° C.

Embodiment 30: The method of any one of Embodiments 26 to 29, wherein the melt-mixing involves first melt-mixing the polymer in a heated screw extruder and then adding the mineral blend to the heated screw extruder.

Embodiment 31: A method of forming a flame retardant object, the method comprising:
heating the flame retardant polymer composition of any one of Embodiments 1 to 24 to form a molten composition; and
contacting a surface of an object with the molten composition to form a flame retardant object.

Embodiment 32: The method of Embodiment 31, wherein the object is an electrical conductor, an automotive part, a building material, an electronic device, or an electrical appliance.

Embodiment 33: A method of forming a flame retardant object, the method comprising: injection molding the flame retardant polymer composition of any one of Embodiments 1 to 24 to form a flame retardant object.

Embodiment 34: The method of Embodiment 33, wherein the flame retardant object forms a housing or an outer surface of an electrical conductor, an automotive part, a building material, an electronic device, or an electrical appliance.

The examples below are intended to further illustrate protocols for preparing, characterizing the flame resistant polymer composition, and uses thereof, and are not intended to limit the scope of the claims.

### Example 1

### Objectives

The objective is to develop a flame retardant mineral solution which is able to at least partially replace aluminum hydroxide (ATH) in polyolefin compounds for wire and cable application, more specifically, a compound for sheathing and isolation low voltage wire and cables. Four different minerals were considered.

Magnesium hydroxide (MH) provides a self-extinguishing ability to the compound due to the endothermic process of thermal decomposition the hydroxyl groups to steam, which reduces O₂ concentration and combustible gases on the surface of the polymer piece, thus reducing the rate of combustion.

Hydroxide kaolin or calcined kaolin has a lamellar structure that reduces the permeability of combustible gases through the polymeric matrix. Also, kaolin has a positive influence in the char skin formation that provides thermally isolation. See M. Batistella et al. Polymer Degradation and Stability 100 (2014) 54-62. “Fire retardancy of ethylene vinyl acetate/ultrafine kaolinite composites”—incorporated herein by reference in its entirety.

Calcium carbonate (GCC) may have intumescent features and may positively influence char skin formation when CaCO₃ is applied with a fatty acid and in a polymer matrix, which produces an organic acid during burning process. See S. Bellayer et al. Polymer Degradation and Stability 94 (2009) 797-803. “Mechanism of intumescence of a polyethylene/calcium carbonate/stearic acid system” and A. Lundgren et al. Journal of Fire Sciences 2007, 25, 287. “Influence of the Structure of Acrylate Groups on the Flame Retardant Behavior of Ethylene Acrylate Copolymer Modified with Chalk and Silicone Elastomer”—each incorporated herein by reference in its entirety.

Titanium dioxide as a white pigment to adjustment color properties.

Fatty acids are widely used coating agents and can improve significantly the dispersibility and flowability of mineral product when mixing with molten thermoplastics See S. Bellayer et al. (2009) and A. Lundgren et al.—each incorporated herein by reference in its entirety.

The stage of development of prototype had three phases, which each one had a different design of experiments to study different hypothesis, but one by one generates an evolution to the final prototype.

In phase 1, two process variables (screw speed and temperature profile) and three different flame retardants additives, Hydral 710 (ATH) and two prototypes (FRM 012017 and FRM 022017) were studied based in ternary blend among kaolin, magnesium hydroxide, and calcium carbonate.

In phase 2, same process variables of phase 1 and three different flame retardants, Hydral 710 (ATH) and two prototypes (FRM 022017 and FRM 062017) were studied based in the same ternary blend, but with particle size distribution differentiation between them.

In phase 3, the effect of small amounts of dicumyl peroxide in flame retardancy of compounds produced with prototype FRM 062017 in the phase 2 structure were studied. See L. Zhang et al. J Mater Sci (2007) 42:4227-4232. “Aluminum hydroxide filled ethylene vinyl acetate (EVA) composites: effect of the interfacial compatibilizer and the particle size”—incorporated herein by reference in its entirety.

After sequence of phases to find a solution, it was concluded that prototype FRM 062017 reach VO result of flame retardancy in vertical UL94 method and statically no difference between Hydral 710 (ATH) in terms of mechanical properties, when it is in combination with small amount of dicumyl peroxide. This prototype allowed the production with a higher temperature profile (until 200° C. molten polymer compound) and screw speed than usual for ATH compounds, resulting in improvement of surface roughness and extrudability in mono screw extruder. Each phase will be described and commented in detail.

Objective: Developing an engineering mineral solution to at least partially replace aluminum hydroxide (Martinal OL104 and Apyral 60CD) in the PE/EVA compound applied to isolation and sheathing low tension cables and wires. This will focus on developing an engineered mineral solution which is able to maintain flame retardancy, mechanical, thermal, and electrical properties as determined standard ABNT NBR 13248-15 for wire and cable assemblies. In addition, keeping the smoothness of the cable surface and improving processability to the polyolefin compound to reach better output performance by increasing temperature profile and screw speed compared to the conventional material.

### Example 2

Phase 1—Study Prototype 012017 and Prototype 022017

Considering the concepts listed above, four minerals were chosen, which are two kaolin, one GCC, and one MH, that were put together to have synergic performance in the polyolefin compound when coated with a fatty acid. They were chosen due to their particle size distribution (kaolin and GCC), and the two kaolins were chosen to understand if calcination plays some end differentiation, and MH was the only option for this raw material. The hydrous kaolin used had a shape factor of less than 7. All prototypes were produced by standard conditions currently used for coating materials. Table 1 shows the relevant physical and chemical results for the study.

TABLE 1
Mineral prototype formulation and physical-chemical results

| | | Hydrous | Calcined | | Magnesium | Prototype | Prototype |
|---|---|---|---|---|---|---|---|
| Materials | Hydral 710 | Kaolin | Kaolin | GCC | Hydroxide | 012017 | 022017 |
| Aluminum Hydroxide (ATH) | 100% | — | — | — | — | — | — |
| Hydrous Kaolin | — | 100% | — | — | — | — | 32.15% |
| Ground Calcium Carbonate | — | — | — | 100% | — | 32.15% | 32.15% |
| Magnesium Hydroxide | — | — | — | — | 100% | 32.15% | 32.15% |
| Calcined Kaolin | — | — | 100% | — | — | 32.15% | — |
| Fatty Acid | — | — | — | — | — | 1.08% | 1.08% |
| Irganox 1010 | — | — | — | — | — | 0.002% | 0.002% |
| Silicon oil (350 Cps) | — | — | — | — | — | 0.49% | 0.49% |
| Titanium Dioxide (Tiona | — | — | — | — | — | 1.97% | 1.97% |
| RKB2) | | | | | | | |
| PSD_{Laser Diffraction} − D₁₀ (μm) | 0.65 | 0.53 | 0.76 | 0.68 | 1.15 | 0.62 | 0.49 |
| PSD_{Laser Diffraction} − D₅₀ (μm) | 1.75 | 1.41 | 2.35 | 2.20 | 7.17 | 2.84 | 2.49 |
| PSD_{Laser Diffraction} − D₉₉ (μm) | 5.04 | 7.29 | 19.64 | 11.82 | 23.56 | 22.68 | 21.78 |
| PSD_{Laser Diffraction} − D_{average} | 1.94 | 1.83 | 3.94 | 3.25 | 8.10 | 4.87 | 4.52 |
| (μm) | | | | | | | |
| Linseed Oil Absorption | 30.0 | 49.6 | 88.1 | 20.9 | 26.0 | 30.7 | 26.9 |
| (g/100 g) | | | | | | | |
| Moisture (%) | 0.30 | 5.04 | 0.65 | 0.30 | 0.50 | 0.40 | 0.4 |
| Loss Ignition (%) | 31.27 | 13.10 | 0.25 | 42.40 | 28.14 | 23.59 | 27.82 |
| Electrical Conductivity | 65.74 | 340.0 | 61.46 | 84.0 | 108.5 | 79.76 | 193.4 |
| (μS/cm) | | | | | | | |
| Bulk density (g/cm³) | 0.42 | 1.00 | 0.31 | 0.83 | 0.74 | 0.54 | 0.54 |
| B.E.T (m²/g) | 3.1 | 10.7 | 14.1 | 3.0 | 8.2 | 7.5 | 6.0 |

Compounding process was made by the compositions shown in Tables 2 and 3. Ten experiments were planned following design of experiments (DoE) and formulation reference. Two experiments were with ATH reference in two condition of screw speed and 8 experiments involved changing two screw speed, two temperature profile, and two prototypes (kaolin, GCC and MH). The real variables used in the twin-screw extruder are shown below with a description of how those variables were set.

TABLE 2
Formulation Reference.

| | Reference | Prototype 01 | Prototype 02 |
|---|---|---|---|
| Materials | (% wt) | (% wt) | (% wt) |
| EVA Braskem HM728 | 12.1 | 12.1 | 12.1 |
| LLDPE Braskem LH218 | 24.5 | 24.5 | 24.5 |
| Bluesil MF 175 | 1.5 | 1.5 | 1.5 |
| Polybond 3200 | 1.5 | 1.5 | 1.5 |
| Irganox 8215 | 0.4 | 0.4 | 0.4 |
| Hydral 710 | 60.0 | — | — |
| Prototype 012017 | — | 60.0 | — |
| Prototype 022017 | — | — | 60.0 |
| Total | 100.0 | 100.0 | 100.0 |

TABLE 3
DoE (Orthogonal matrix) to Prototype 012017 × Prototype 022017

| | Factors | | |
|---|---|---|---|
| | | Flame Retardant | Temperature Profile |
| Experiments | Speed Screw | (FR) | Coefficient |
| 1 | Δ ≠ 0 | 012017 | 28 |
| 2 | Δ = 0 | 012017 | 28 |
| 3 | Δ ≠ 0 | 022017 | 28 |
| 4 | Δ = 0 | 022017 | 28 |
| 5 | Δ ≠ 0 | 012017 | 56 |
| 6 | Δ = 0 | 012017 | 56 |
| 7 | Δ ≠ 0 | 022017 | 56 |
| 8 | Δ = 0 | 022017 | 56 |
| 9 | Δ ≠ 0 | Hydral 710 | 28 |
| 10 | Δ = 0 | Hydral 710 | 28 |

The variables and their levels are listed below:

1. Delta of Screw Speed:

a. Δ=0 (−1)

b. Δ#0 (+1)

The first level of screw speed (Δ=0) is the rotation necessary to produce the compound loaded with Hydral 710 (ATH) in stable conditions such as low torque and low of molten temperature (Tm). However, second level (Δ≠0) is the rotation necessary to produce the reference compound (Hydral 710) in stable condition but in the torque limit of extruder and the maximum molten temperature of 170° C.

For example, if the screw speed was set at 300 rpm to produce the reference compound in the low torque and low Tm, that would be considered the Δ=0 (−1). And, if the screw speed was set at 400 rpm to produce the reference compound in the limit torque of extruder and Tm=170° C. that would be considered the Δ=100 (+1).

2. Temperature profile coefficient:

a. 28 (−1)

b. 56 (+1)

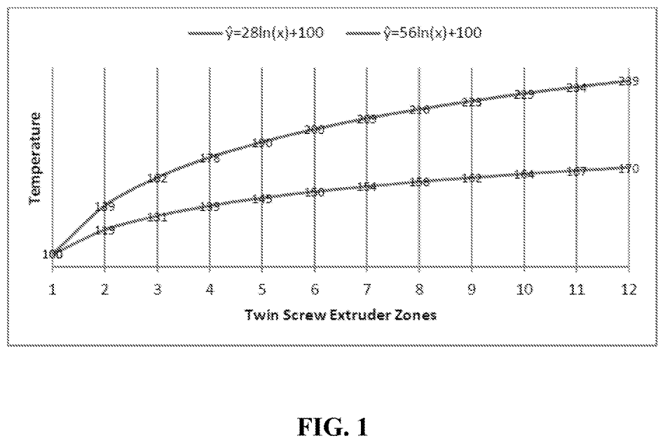

A logarithmic equation is presented to describe the temperature profile that will be applied in the twin screw extruder. This mathematical artifice was used to reduce the number of variables from 9 or 10 to 1, which is represented by the angular coefficient of the equation [ŷ=k*ln(x)+b]. FIG. 1 shows the graphic representation of the curves.

3. Flame retardant prototype

a. Prototype 012017

b. Prototype 022017

Design of Experiments were run using a ZE 25A×46D UTXi Berstorff twinscrew extruder. FIGS. 2A and 2B show the schematic diagram of the twin-screw extruder. Feed procedure of flame retardant (FR) into the extruder had to be divided because of the amount the FR mineral. The mean feeder receive a pre-blend (Bluesil MF175 and EVA) by spiral screw feeder, other pre-blend (Irganox B215 and Polybond 3200) and LLDPE independently. Two side feeders received only the FR minerals which were divided in a 3:1 ratio to guarantee the dispersion and prevent the mineral backup with the extruder throughput of 10 kg/hr. The first side feeder in zone 3 received 45 wt % (from the 60 wt %) and the second in zone 5 received 15 wt % (from the 60 wt %). Table 4 shows the real temperature profile adjusted by an extruder, and Table 5 show the real variables set to run the trials.

TABLE 4
Set points of temperature profile

| | Low temperature | High temperature |
|---|---|---|
| Extruder Zone | profile | profile |
| Zone 1 (° C.) | 30 | 30 |
| Zone 2 (° C.) | 100 | 100 |
| Zone 3 (° C.) | 119 | 139 |
| Zone 4 (° C.) | 139 | 178 |
| Zone 5 (° C.) | 150 | 200 |
| Zone 6 (° C.) | 158 | 216 |
| Zone 7 (° C.) | 164 | 229 |
| Zone 8 (° C.) | 170 | 239 |
| Zone 12 | 170 | 239 |
| Zone 13 Die (° C.) | 170 | 239 |

TABLE 5
Design of experiments real conditions

Process condition

| Experiment | Materials | RPM | Temperature |
|---|---|---|---|
| 1 | Hydral 710 | 150 | Low |
| 2 | Hydral 710 | 250 | High |
| 3 | Prototype 012017 | 150 | Low |
| 4 | Prototype 012017 | 250 | Low |
| 5 | Prototype 012017 | 150 | High |
| 6 | Prototype 012017 | 250 | High |
| 7 | Prototype 022017 | 150 | Low |
| 8 | Prototype 022017 | 250 | Low |
| 9 | Prototype 022017 | 150 | High |
| 10 | Prototype 022017 | 250 | High |

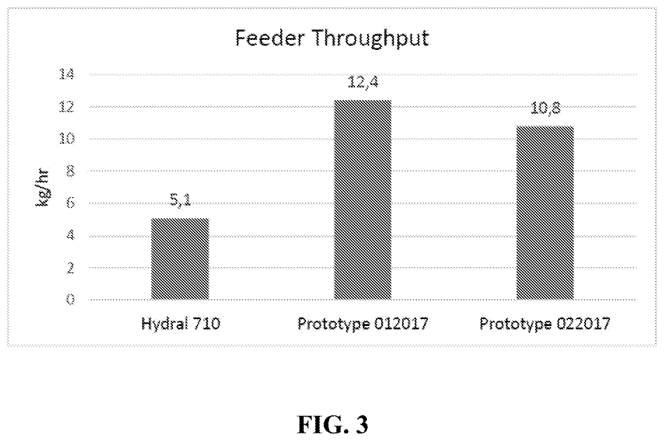

The feeder throughput in zone 3 (FIG. 3) had different results compared on ATH and prototypes, which is related to the bulk density observed in the mineral composition. The coating solution also plays an important role in the flowability of the mineral composition. Considering that the feeder throughput in zone 3 is directly related to extruder productivity, during the trials it would be possible to achieve the 20 kg/hr for prototypes, but the study was a comparative one where all materials were produced by same condition of throughput 10 kg/hr.

From the 10 experiments, only 3 were not possible to produce because of excessive bubble and pore generation; these samples were Hydral 710 (ATH) (250 RPM and Low T) and Prototype 012017 (High T 150 and 250 RPM). The other compounds had good processability under the conditions set by the DoE.

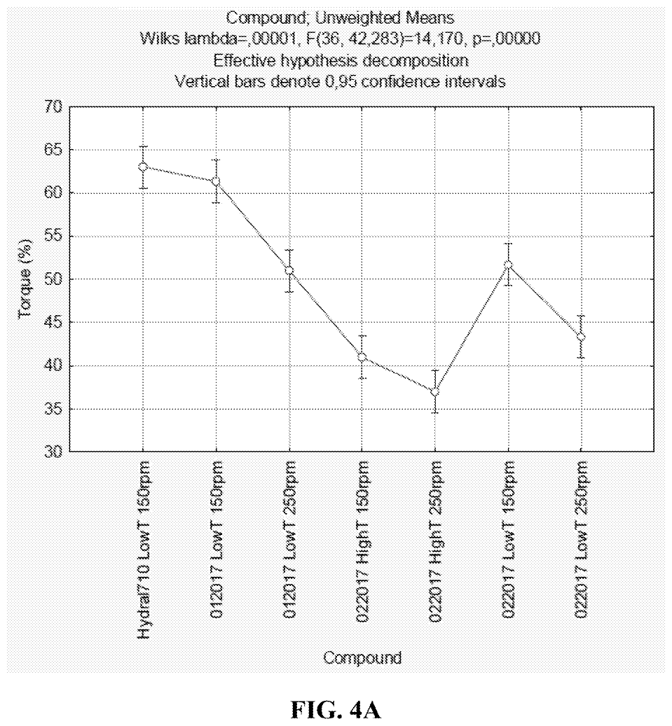

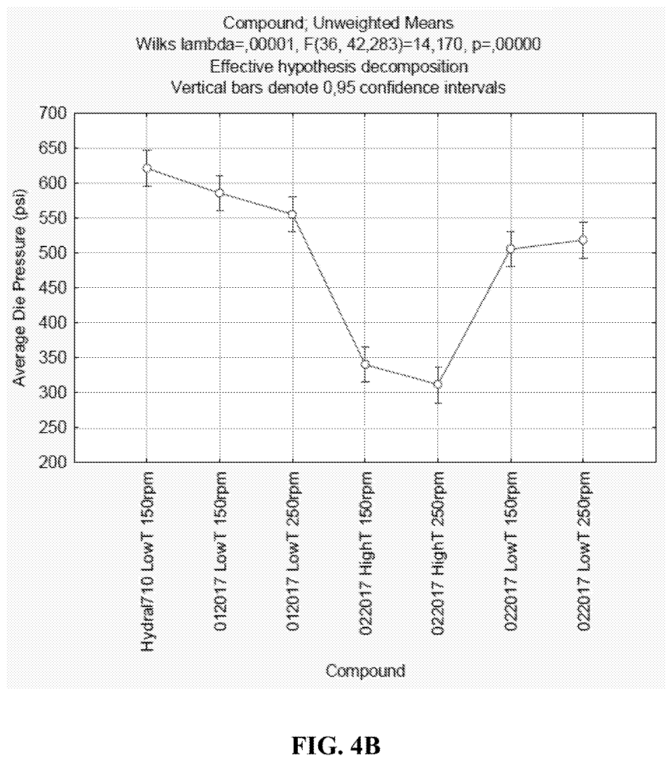

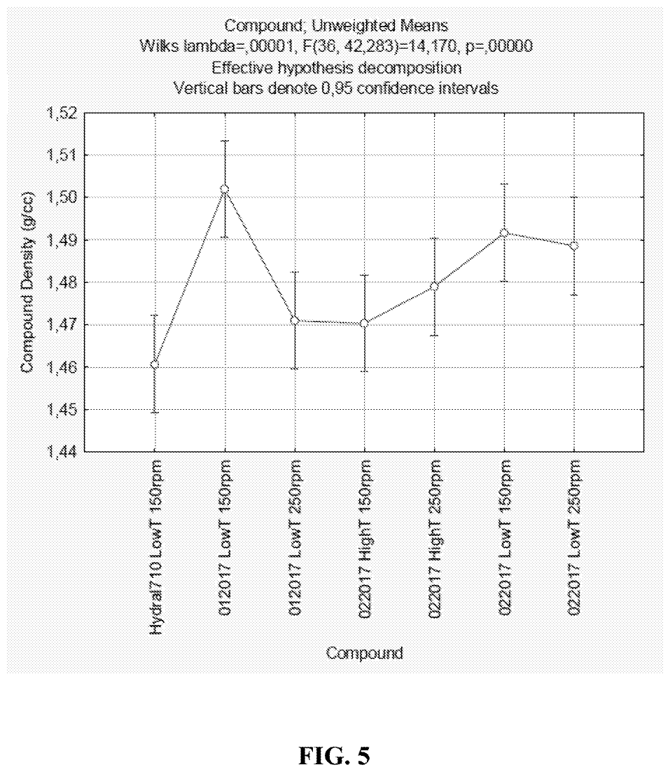

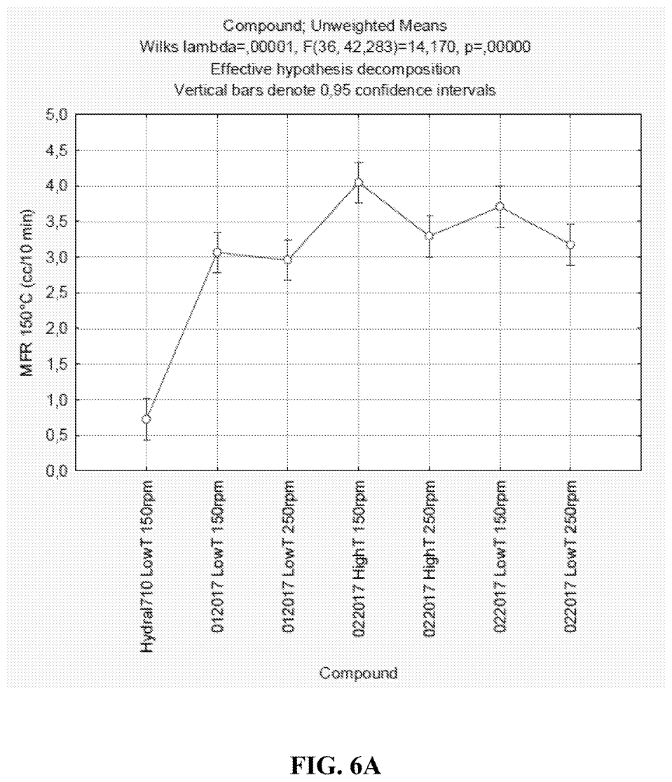

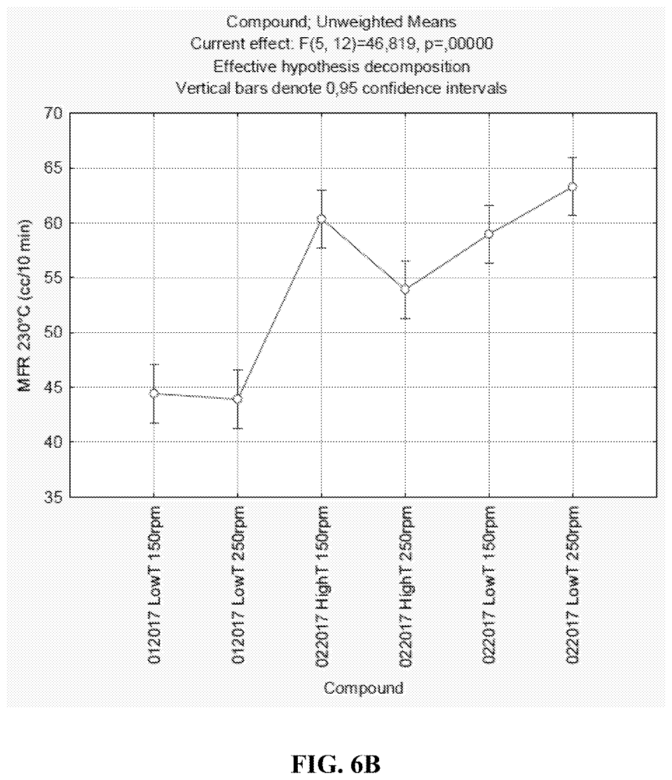

Process results show that FR prototypes generate less torque and die pressure during the compounding than ATH under same condition of extrusion, as shown in FIGS. 4A and 4B, this effect is related to compounds' viscosity which is influenced by filler loading, surface area, and temperature. Notice that the densities of compounds as show in FIG. 5 are comparable, demonstrating that side feeders worked well. Even prototypes have more surface area and show less compound viscosity due to different interaction between coating particles and polymer. Another cause of reduced viscosity is the increased temperature that is applicable only for prototypes because they are more stable under higher temperature and screw speed than ATH. Melt flow rate (MFR) was measured in two conditions of temperature, 150° C. and 230° C. under 21.6 kg to understand the differences in flow properties during process. See ASTM D 1238-10: Standard Test Method for Melt flow Rates of Thermoplastics by Extrusion Plastometer, incorporated herein by reference in its entirety. FIGS. 6A and 6B show the melt flow rate MFR results.

All compounds were characterized in terms of flame retardancy (vertical UL94 method), mechanical properties (ASTM D 638, die IV) and MFR. See ASTM D 1238-10: Standard Test Method for Melt flow Rates of Thermoplastics by Extrusion Plastometer; UL94—Standard for Tests for Flammability of Plastic Materials for Parts in Devices and Appliances; and ASTM D 638-14: Standard Test Method for Tensile Properties of Plastics—each incorporated herein by reference in its entirety.

In addition, roughness index was determined considering tactile sensation and visual observation of the “spaghetti” extruded. The specimens for UL94 and tensile strength and strain at break properties were molded by roll mill under 125° C. to plasticize the pellets and the plates were molded in hot press where the sample stays 2 min under 150° C. and 3 min under environment temperature, with a nominal pressure of 37 kgf/cm².

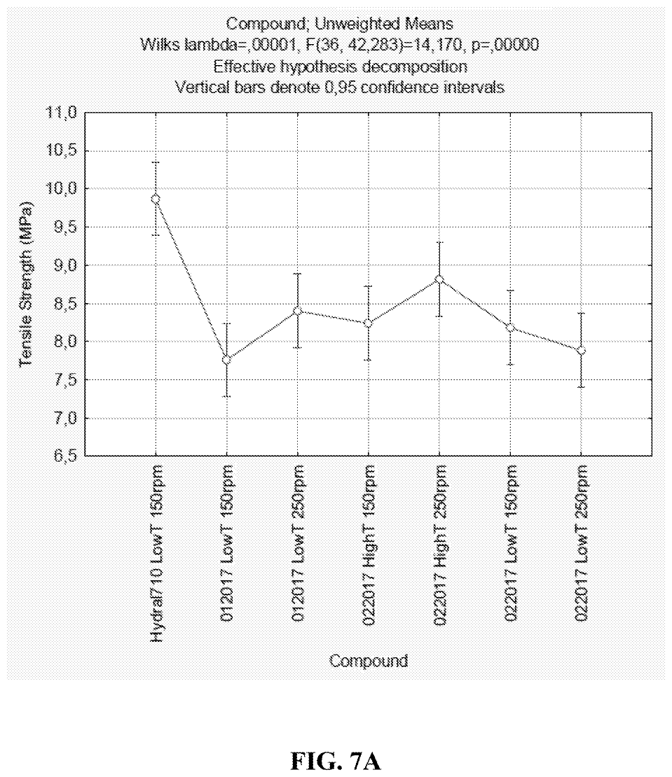

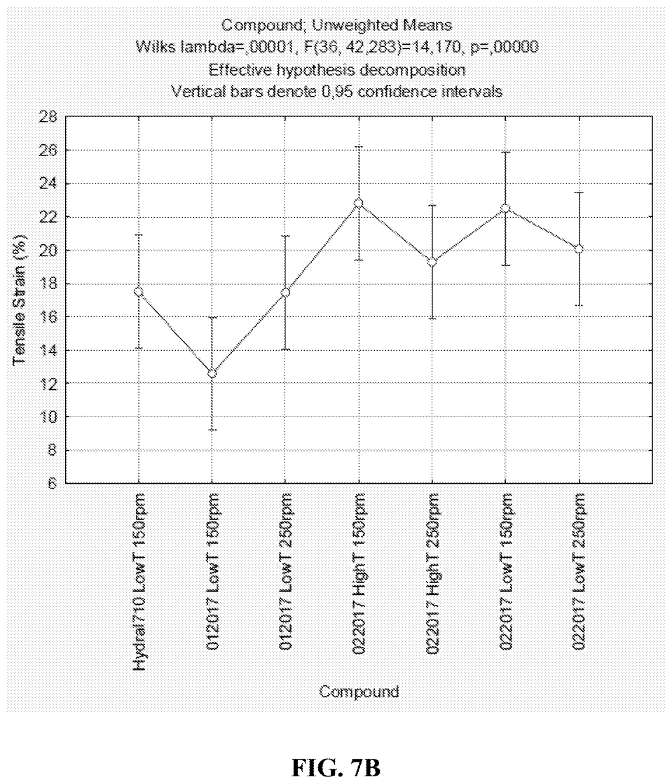

Interesting results were observed for prototype 022017 that reached VO and had the best roughness index when the material was submitted in the twin-screw extruder with the High Temperature profile and 250 RPM. Table 6 shows the UL94 and roughness index for all compounds produced. It is possible to observe in compounds loaded with prototype 022017 that their roughness index decreases when the material is processed under HighT and 250 RPM, so this effect may be related to plastification behavior of prototype compounds. Tensile strength property, shown in FIGS. 7A and 7B, had results for prototypes in different process conditions demonstrate slightly lesser performance than compound loaded with ATH due to average and distribution particle size of prototypes being higher and broader than ATH. In addition, mechanical properties for compounds loaded with prototype 022017 are regardless from temperature profile (High and Low) and screw speed (150 and 250 RPM).

TABLE 6
UL94 and Roughness index results

| | Hydral 710 | 012017 | 012017 | 022017 | 022017 | 022017 | 022017 |
|---|---|---|---|---|---|---|---|
| | (LowT, | (LowT, | (LowT, | (HighT, | (HighT, | (LowT, | (LowT, |
| Compound | 150 rpm) | 150 rpm) | 250 rpm) | 150 rpm) | 250 rpm) | 150 rpm) | 250 rpm) |
| UL94 | V0 | NC | NC | NC | V1 | V0 | NC |
| Roughness | 1 | 5 | 5 | 3 | 2.5 | 5 | 4 |
| index¹ | | | | | | | |

1—Roughness index (Visual observation and tactile sensation) 5 is most rough, and 1 is least rough.

### Example 3

Phase 2—CCDM External Lab

Prototype 022017 had acceptable flame retardancy and roughness index performance when it was processed by twin-screw extruder in two process conditions (HighT; High Speed and LowT; Low Speed). Therefore, the project continues to upgrade the prototype 022017, reducing average particle size and narrowing the particle size distribution. First, MH was milled by opposed jet mill, secondly, kaolin and GCC grades were changed. Prototype 062017 combines all modifications made in mineral matrix, and it was by standard conditions currently used for coating materials. Table 7 shows the relevant physical and chemical results for each material used in the study.

TABLE 7
Mineral prototype formulation and physical-chemical results

| | | | | Magne- | |
|---|---|---|---|---|---|
| | | | | sium | Proto- |
| | Hydral | | | Hydro- | type |
| Materials | 710 | Hydrous | GCC | xide | 062017 |
| Aluminum | 100% | — | — | — | — |
| Hydroxide (ATH) | | | | | |
| Hydrous Kaolin | — | 100% | — | — | 32.15% |
| Ground Calcium | — | — | 100% | — | 32.15% |
| Carbonate | | | | | |
| Magnesium | — | — | — | 100% | 32.15% |
| Hydroxide | | | | | |
| Fatty Acid | — | — | — | — | 1.08% |
| Irganox 1010 | — | — | — | — | 0.002% |
| Silicon oil | — | — | — | — | 0.49% |
| (350 Cps) | | | | | |
| Titanium Dioxide | — | — | — | — | 1.97% |
| (Tiona RKB2) | | | | | |
| PSD_{Laser Diffraction} − | 0.65 | 0.56 | 0.62 | 0.79 | 0.57 |
| D₁₀ (μm) | | | | | |
| PSD_{Laser Diffraction} − | 1.75 | 1.87 | 2.60 | 2.47 | 2.26 |
| D₅₀ (μm) | | | | | |
| PSD_{Laser Diffraction} − | 5.04 | 7.76 | 17.05 | 7.63 | 11.17 |
| D₉₉ (μm) | | | | | |
| PSD_{Laser Diffraction} − | 1.94 | 2.37 | 4.11 | 2.80 | 2.96 |
| D_{average} (μm) | | | | | |
| Linseed Oil | 30.0 | 38.2 | 17.3 | 30.7 | 18.2 |
| Absorption | | | | | |
| (g/100 g) | | | | | |
| Moisture (%) | 0.30 | 4.17 | 0.3 | 1.18 | 0.6 |
| Loss Ignition | 31.27 | 12.91 | 41.98 | 28.45 | 28.43 |
| (%) | | | | | |
| Electrical | 65.74 | 392.7 | 100.7 | 221.7 | 164.7 |
| Conductivity | | | | | |
| (μS/cm) | | | | | |
| Bulk density | 0.42 | 1.06 | 0.91 | 0.62 | 0.77 |
| (g/cm³) | | | | | |
| B.E.T (m²/g) | 3.1 | 16.5 | 2.9 | 10.5 | 8.3 |

Compounds loaded with prototypes 022017 and 062017 were produced in a twin-screw extruder “COPERION” (Diameter 35 mm and L/D 44) for compounding under two different process condition (HighT; High Speed and LowT; Low Speed) which achieved in better flame retardancy results. ATH was produced under same condition (LowT; Low Speed) in the first study. Formulation reference was not changed and was used as in the same batches of first study. Due to the present extruder generating more shear, new parameters had to be set for screw speed, but temperature profile stayed the same from first study. Table 8 shows set points for temperature profile, and Table 9 shows the design of experiments in real conditions of process.

TABLE 8
Set points of temperature profile

| | Low temperature | High temperature |
|---|---|---|
| Extruder Zone | profile | profile |
| Zone 1 (° C.) | 40 | 40 |
| Zone 2 (° C.) | 100 | 100 |
| Zone 3 (° C.) | 119 | 139 |
| Zone 4 (° C.) | 131 | 162 |
| Zone 5 (° C.) | 145 | 178 |
| Zone 6 (° C.) | 150 | 190 |
| Zone 7 (° C.) | 154 | 200 |
| Zone 8 (° C.) | 158 | 209 |
| Zone 9 (° C.) | 162 | 216 |
| Zone 10 (° C.) | 164 | 223 |
| Die (° C.) | 167 | 229 |

TABLE 9
Design of experiments real conditions

Process condition

| Experiment | Materials | RPM | Temperature |
|---|---|---|---|
| 1 | Hydral 710 | 70 | Low |
| 2 | Prototype 022017 | 70 | Low |
| 3 | Prototype 022017 | 100 | High |
| 4 | Prototype 062017 | 70 | Low |
| 5 | Prototype 062017 | 100 | High |

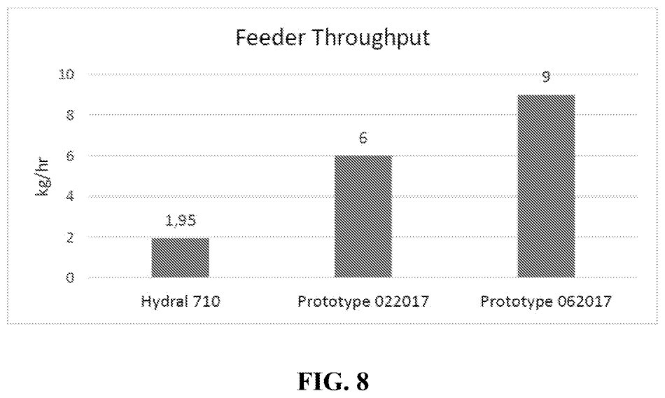

FR minerals were fed by one side feeder positioned in Zone 6, and as a result, flowability of minerals is important to determine throughput of extruder. Notice in FIG. 8 that feeder throughput of the three FR minerals used in the study and prototype 062017 has better flow property than other FR minerals due to presence of the hydrophobic coating. However, compounds loaded with prototype were produced in constant 10 kg/hr extruder output.

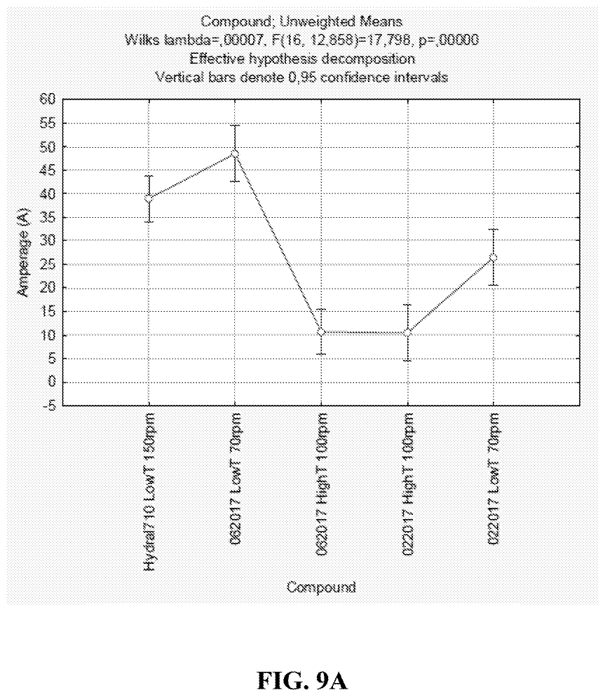

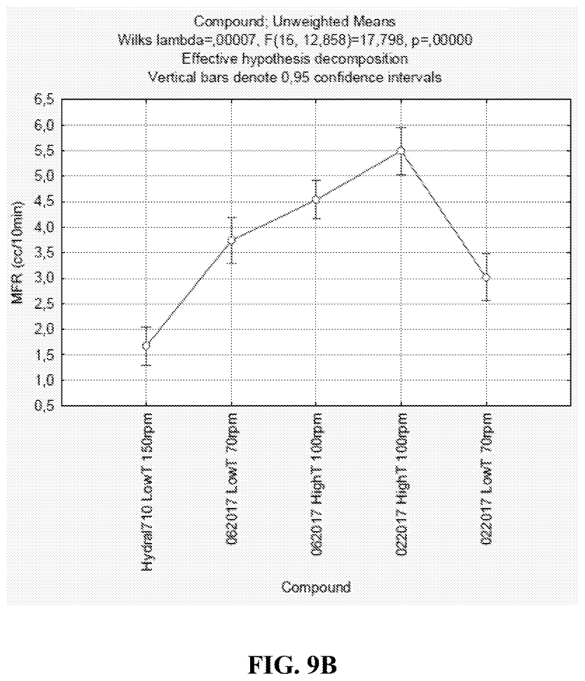

CCDM's extruder doesn't have torque controller in its CLP, but it was possible to take the amperage values of extruder engine which varies proportionally when the material flow resistance varies. Even the changes in surface area between prototypes that was not the mean factor to influence the extruder amperage, in fact, temperature profile was the mean factor to affect this variable as it is possible to observe in FIG. 9A. ATH compound has lower MFR than prototypes compound as seen in the first study. Comparing prototype compounds among each other it is possible to see a tendency of compound produced by higher conditions present higher MFR results as noticed in FIG. 9B.

After compounding, a mono-screw extruder Miotto EM 03/45E (Diameter 45 mm and L/D 25) was used by CCDM to produce sheets which were evaluated the process and roughness performance. Notice in Table 10 that die pressure was fixed to understand the behavior of extruder during extrusion of those different materials. Compounds produced by twin-screw extruder in higher conditions of temperature and speed show better performance in terms of process and roughness in the sheets produced by mono-screw extruder. Thus, it is possible to mold compounds by high speed (higher shear heating). The effect observed is related to their process history in terms of plastification and polymer-particle wettability.

TABLE 10
Mono-screw extruder results

| | Temperature | | | | Die | Rough- |
|---|---|---|---|---|---|---|
| | Zone | Zone | Zone | Speed | Pressure | ness |
| Compound | 1 | 2 | 3 | (RPM) | (Bar) | Index |
| Hydral 710 | 140 | 150 | 160 | 10 | 70 | 1 |
| (LowT, 150 rpm) | | | | | | |
| 022017 | 140 | 150 | 160 | 15 | 70 | 2.5 |
| (HighT, 100 rpm) | | | | | | |
| 022017 | 140 | 150 | 160 | 11 | 70 | 5 |
| (LowT, 70 rpm) | | | | | | |
| 062017 | 140 | 150 | 160 | 25 | 70 | 1.5 |
| (HighT, 100 rpm) | | | | | | |
| 062017 | 155 | 155 | 160 | 11 | 70 | 3 |
| (LowT, 70 rpm) | | | | | | |

1—Roughness index (Visual observation and tactile sensation) 5 is most rough and 1 is least rough.

All compounds were characterized in terms of flame retardancy (vertical UL94 method), mechanical properties (ASTM D 638, die IV) and MFR. See ASTM D 1238-10; UL94; and ASTM D—each incorporated herein by reference in its entirety. In addition, roughness index was determined considering tactile sensation and visual observation of the sheets extruded by mono-screw extruder. The specimens for UL94 and tensile strength and strain at break properties were molded by roll mill under 125° C. to plasticize the pallets and the plates were molded in hot press where the sample stayed for 2 min under 150° C. and 3 min under environment temperature, nominal pressure was 37 kgf/cm².

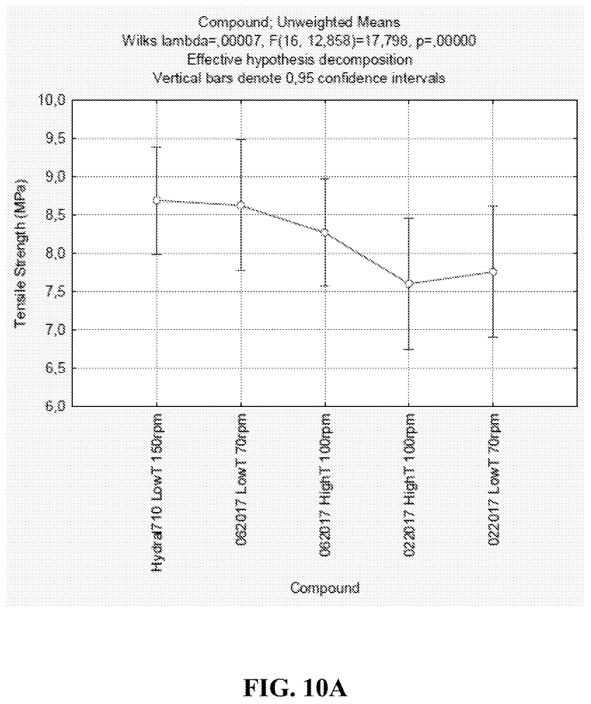

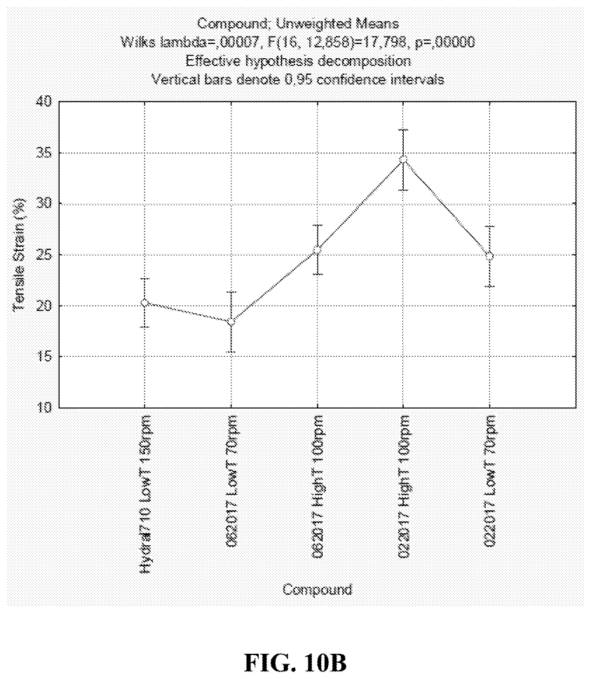

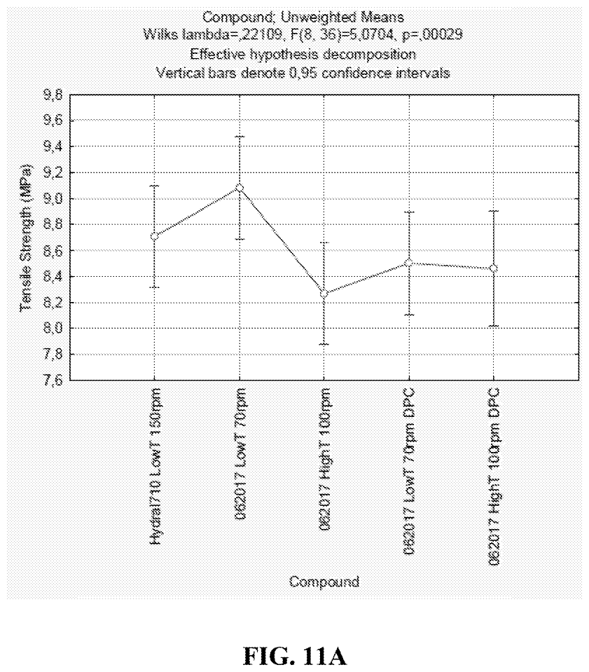

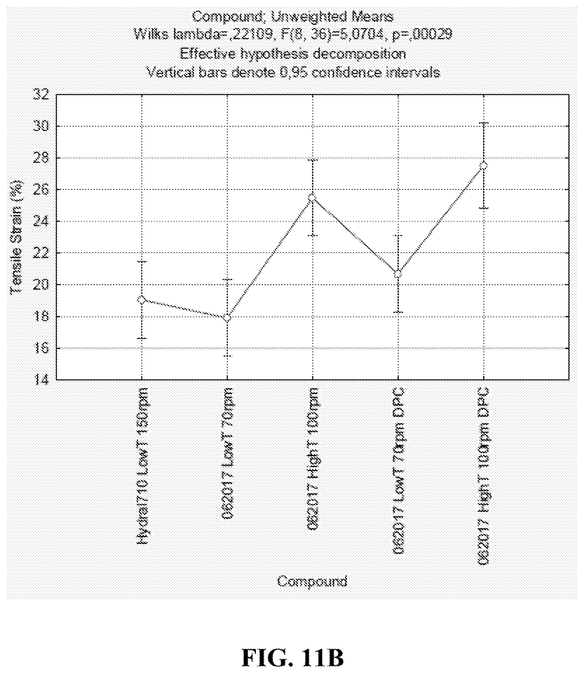

History process in twin-screw extruder plays an important influence in mechanical properties, specifically tensile strain at break that may be observed in FIGS. 10A and 10B, strain results of prototypes are higher when they were produced under higher conditions of process and those show better performance than compound loaded with ATH. However, there are no statically difference in terms of tensile strength at break between compounds loaded with prototypes 062017 and ATH that is an effect caused by PSD reducing intentionally in prototype 062017 against prototype 022017 that has slight lesser performance than ATH.

Particle size distribution significantly influences flame retardancy. As shown in Table 10, prototype 062017 has better performance than prototype 022017 when compared in both conditions of process. However, prototype 022017 reduced its performance when comparing the studies, and this may be caused by differences in shear rate between the extruder used, reducing some properties of polymer matrix like length chain (molar weight). In addition, PSD may be a second mean factor that reduced flame retardancy performance of prototype 022017, but in prototype 062017 bring better results even if the concentration of FR mineral reduced almost 5 wt % in magnitude as happened in prototype 022017 when compared in both studies. Table 11 shows the flame retardancy, density, and mineral content in the compounds.

TABLE 11
Compound results

| | Mineral | | | | | | | |
|---|---|---|---|---|---|---|---|---|
| | Hydral 710 | | Prototype 022017 | | | | Prototype 062017 | |
| Lab | Imerys US | CCDM | Imerys US | CCDM | Imerys US | CCDM | CCDM | |
| Process condition | T↓; | T↓; | T↓; | T↓; | T↑; | T↓; | T↓; | T↑; |
| | 150 RPM | 70 RPM | 150 RPM | 70 RPM | 250 RPM | 100 RPM | 70 RPM | 100 RPM |
| Density (g/cm³) | 1.462 | 1.415 | 1.482 | 1.435 | 1.491 | 1.435 | 1.510 | 1.435 |
| | (±0.004) | (±0.007) | (±0.005) | (+0.007) | (±0.002) | (±0.007) | (±0.001) | (±0.007) |
| FR content (% wt) | 63.11 | 58.99 | 60.58 | 56.44 | 60.98 | 56.77 | 60.87 | 55.00 |
| UL94 | V0 | V0 | V0 | NC | V1 | NC | V1 | V1 |

### Example 4

Phase 3—Additive to Improve Flame Retardancy Property

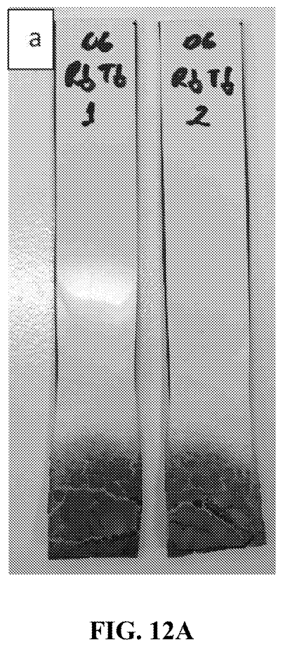

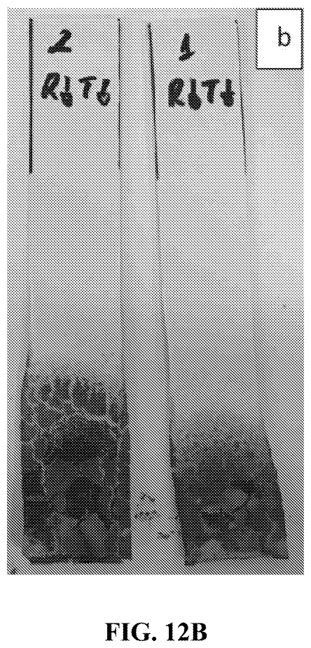

Organic peroxide was found as a solution to increase flame retardancy performance. See L. Zhang et al.—incorporated herein by reference in its entirety. Notice that adding 0.03 wt % of dicumyl peroxide (DCP) in the compound loaded with prototype 062017 increased flame retardancy and kept the mechanical properties in performance. DCP was added by roll mill under 125° C. in 1 min and then molded by hot press, where compounds sheet stay 2 min under 150° C. after that 3 min under environment temperature, nominal pressure was 37 kgf/cm². Table 12 shows the flame retardancy results for each compound with and without DCP. FIGS. 10A and 10B show tensile strength at break and tensile strain at break. FIG. 12 show the picture from specimens after burning test which is possible to observe the compound loaded with prototype 062017 with DCP has a dense char skin compared to the compound without additive that may be the cause of better result achieve in the material loaded with DCP.

TABLE 12
Flame retardancy results.

| | Mineral | | | | |
|---|---|---|---|---|---|
| | Hydral 710 | Prototype 062017 | | | |
| Process | T↓; | T↓; | T↑; | T↓; | T↑; |
| condition | 70 RPM | 70 RPM | 100 RPM | 70 RPM | 100 RPM |
| Dicumyl | No | Yes | Yes | No | No |
| Peroxide | | | | | |
| UL94 | V0 | V0 | NC | V1 | V1 |

In view of the above examples, a mineral solution was developed to at least partially replace ATH applied for wire and cable isolation and sheathing compound flame retardant and keep all properties evaluated in the study with no statistical difference between reference and mineral solution.

It was noticed that the formulation adopted as a reference may be altered, changing the EVA polymer to another with higher MFI (higher molecular weight), the polymer matrix of polymer graphitized with anhydride maleic from PP to LLDPE and increase the amount from 1.5 wt % to 3 wt %. Those changes listed before may improve the scale of mechanical properties and guarantee constant flame retardancy results.

During both phase 1 and phase 2 studies, it was observed that plastification of compound during compounding in twin-screw extruder interfered strongly in the molding by monoscrew extruder and in the global performance of compound loaded with prototypes. Therefore, temperature profile and screw speed have to be adjusted. It can be made by the costumer where FR compound will be produced because of the differences associated to change the twin-screw extruders like screw profile, shear heating, amount and position of side feeder, controllers and extruder size could interfere in the FR compound performance.

Prototype 012017 has technical validation for wire and cable based crosslinked EPR and EPDM, being able to replace 100% of ATH and silanized calcined kaolin. As a result, all properties were kept following the cable specification and standards.

Certain other tests are envisioned. Thermogravimetric analysis is a potential technique to determine the activation energy of the material pyrolysis reaction considering that it is a first order reaction, so having the data from the four curves in different heating rate to each sample. It would be able to fit the straight line for Arrhenius law and consequently determine the activation energy for each material. Therefore, it would allow an understanding of differences in thermal stability behavior during heating process of compounds loaded with prototypes when change the particle size distribution and dicumyl peroxide presence as well as compare ATH compound reference with prototypes compound. Methods based on ASTM D 1641 have a broad use in studies to compare thermal stability under oxidant atmosphere or not between different antioxidants, other usage is for comparing different flame retardant additives, measuring the velocity of thermal decomposition that can retard the material burns. See ASTM D 1641-16: Standard Test Method for Decomposition Kinects by Thermogravimetric Using the Ozawa/Flynn/Wall Method—incorporated herein by reference in its entirety.

### Example 5

This example focused on developing an engineered mineral solution able to keep flame retardancy, mechanical, thermal and electrical properties as determined by standard ABNT NBR 13248-15 for assembled wire and cables. Formulations were adjusted with the aim of keeping cable surface smoothness and improving polyolefin processability by increasing temperature profile and speed screw compared the conventional ATH material.

As summarized below, the example analyzed the impacts of modifying the material and process of the formulations: (1) reducing particle size distribution (PSD) of hydrous kaolin and alkaline earth carbonate; (2) moving from (i) applying fatty acid to all minerals to (ii) applying Aminosilane to only the hydrous kaolin (to maximize the basic sites in the surface of minerals); and (3) adding silica gel flame retardant additive to enhance the performance during vertical burning.

### Prototypes Formulation

TABLE 13
Mineral prototype formulation and physical-chemical results

| | | Refer- | FRM | FRM | FRM | FRM |
|---|---|---|---|---|---|---|
| Materials | | ence | 08 | 11 | 12 | 14 |
| ATH | Apyral 40CD | 100 | — | — | — | — |
| Hydrous | Paraglaze SD | — | 32.31 | — | — | — |
| Kaolin | Amazon Plus | — | — | 32.31 | — | — |
| | Amazon | — | — | — | 32.672 | 32.33 |
| | Plus + 1% | | | | | |
| | Aminosilane | | | | | |
| Dolomite | Micron 1/9CD | — | 32.31 | — | — | — |
| | Micron ½CD | — | — | 32.31 | 32.672 | 32.33 |
| MDH | Itamag 150 D₅₀ | — | 32.31 | 32.31 | 32.672 | 32.33 |
| | 2.5 μm | | | | | |
| Fatty Acid | | — | 1.084 | 1.084 | — | — |
| Anti- | Irganox | — | 0.002 | 0.002 | — | — |
| oxidant | 1010 | | | | | |
| Silica | Gasil AB 705 | — | — | — | — | 1.00 |
| TiO₂ | Tiona RKB2 | — | 1.984 | 1.984 | 1.975 | 2.01 |
| | Total | 100% | 100% | 100% | 100% | 100% |

As shown in Table 13, formulations 12 and 14 did not include a fatty acid treatment of the hydrous kaolin, dolomite, or MDH. Uncoated particles will exhibit smaller particle size distribution than corresponding coated particles. The hydrous kaolin of formulations FRM 12 and FRM 14 was treated with an aminosilane coupling agent (gamma-aminopropyltriethoxysilane), while the dolomite and MDH were untreated. Formulation FRM 14 included a 1% silica gel to act as an additional fire retardant.

### Compounds Formulation

TABLE 14
Formulation Reference.

| | Reference | Compound | Compound | Compound | Compound | Compound | Compound |
|---|---|---|---|---|---|---|---|
| Materials | (% wt) | 01 (% wt) | 02 (% wt) | 03 (% wt) | 04 (% wt) | 05 (% wt) | 06 (% wt) |
| EVA Dupont Elvax 260 | 11.7 | 12.1 | 11.7 | 11.7 | 11.7 | 11.7 | 11.7 |
| LLDPE Braskem LH218 | 23.4 | 24.5 | 23.4 | 23.4 | 23.4 | 23.4 | 23.4 |
| Bluesil MF 175 | 1.5 | 1.5 | 1.5 | 1.5 | 1.5 | 1.5 | 1.5 |
| Fusabond P613 | 3.0 | 1.5 | 3.0 | 3.0 | 3.0 | 3.0 | 3.0 |
| Irganox B215 | 0.4 | 0.4 | 0.4 | 0.4 | 0.4 | 0.4 | 0.4 |
| Apyral 40CD | 60.0 | — | — | — | — | — | — |
| Prototype FRM 08 | — | 60.0 | 60.0 | — | — | — | — |
| Prototype FRM 11 | — | — | — | 60.0 | — | — | — |
| Prototype FRM 12 | — | — | — | — | 60.0 | — | — |
| Prototype FRM 14 | — | — | — | — | — | — | 60.0 |
| Total | 100.0 | 100.0 | 100.0 | 100.0 | 100.0 | 100.0 | 100.0 |

Compounds for analysis were produced by pre-blending, dispersion, homogenization by roll mill, and molding sheets. Compound constituents were pre-blended by physical mixture of powder and pellets. Dispersion was performed in a lab-scale torque rheometer mixer (Thermo Scientific Haake Banbury) using thermoplastic rotors at a temperature of 150° C. and a speed of 60 RPM. Homogenization was performed for 2 minutes on a lab scale roll mill at a process temperature of process 125° C. Sheets were molded by hot press under a pressure of for 37 kgf/cm² for two minutes at 150° C. and three minutes at 25° C. (cooled by water).

The following mineral properties were assessed: particle size distribution (PSD) was (measured by laser diffraction), oil absorption, B.E.T. surface area, moisture and loss ignition, electrical conductivity, and bulk density. Compound properties assessed included flammability (per UL94), mechanical properties (per ASTM D 638 die type IV), gloss (after molding in two-roll mill) (to assess surface properties; torque×time and temperature (assessed with Banbury mixer); aspect and gloss (measured after mono screw extruder).

Assessments of a compound produced with FRM 08 show low surface quality during extrusion in lab scale mono screw extruder. Further tests were performed with formulations having hydrous kaolin and diatomite (Ground Calcium Carbonate) with particle size distributions having smaller D99 fractions (as measured by laser diffraction). Table 15 presents some physical properties of mineral raw materials and Table 16 shows the prototype formulation properties.

TABLE 15
Raw materials physical properties

| | | | | Amazon | | | |
|---|---|---|---|---|---|---|---|
| | | | Amazon | Plus + 1% | Micron | Micron | Itamag 150 |
| | Apyral | Paraglaze | Plus | Aminosilane | 1/9CD | ½CD | (2.5 μm) |
| Materials | 40CD | Kaolin | Kaolin | Kaolin | GCC | GCC | MDH |
| Aluminum Hydroxide (ATH) | 100% | — | — | — | — | — | — |
| Hydrous Kaolin | — | 100% | 100% | 100% | — | — | — |
| Ground Calcium Carbonate | — | — | — | — | 100% | 100% | — |
| Magnesium Hydroxide | — | — | — | — | — | — | 100% |
| PSD − D₁₀ (μm) | 0.61 | 0.56 | 0.10 | 0.61 | 0.62 | 0.40 | 0.79 |
| PSD − D₅₀ (μm) | 1.39 | 1.87 | 0.45 | 1.54 | 2.60 | 1.47 | 2.47 |
| PSD − D₉₉ (μm) | 4.57 | 7.76 | 2.12 | 6.93 | 17.05 | 7.21 | 7.63 |
| PSD − D_{average} (μm) | 1.60 | 2.37 | 0.58 | 1.93 | 4.11 | 1.88 | 2.80 |
| Linseed Oil Absorption | 30.0 | 38.2 | 47.5 | 46.4 | 17.3 | 22.6 | 30.7 |
| (g/100 g) | | | | | | | |
| Moisture (%) | 0.30 | 4.17 | 0.39 | 0.32 | 0.3 | 0.50 | 1.18 |
| Loss Ignition (%) | 31.27 | 12.91 | 13.72 | 13.75 | 41.98 | 40.98 | 28.45 |

TABLE 16
Formulation physical properties

| | Apyral | FRM | FRM | FRM | FRM |
|---|---|---|---|---|---|
| Materials | 40CD | 08 | 11 | 12 | 14 |
| PSD − D₁₀ (μm) | 0.61 | 0.45 | 0.37 | 0.46 | 0.58 |
| PSD − D₅₀ (μm) | 1.39 | 2.12 | 1.61 | 1.53 | 1.80 |
| PSD − D₉₉ (μm) | 4.57 | 11.25 | 6.16 | 6.17 | 6.97 |
| PSD − D_{average} (μm) | 1.60 | 2.80 | 1.96 | 1.93 | 2.14 |
| Linseed Oil Absorption | 30.0 | 18.20 | 19.10 | 25.50 | 26.40 |
| (g/100 g) | | | | | |
| Moisture (%) | 0.30 | 0.20 | 0.15 | 0.56 | 0.33 |
| Loss Ignition (%) | 31.27 | 27.39 | 27.93 | 24.73 | 26.92 |
| Electrical Conductivity | 65.74 | 310.7 | 193.0 | 548.5 | 591.0 |
| (μS/cm) | | | | | |
| Bulk density (g/cm³) | 0.42 | 0.59 | 0.34 | 0.41 | 0.39 |

The particle size distributions (PSDs) reported in Tables 15 and 16 were measured via laser diffraction. They were measured before formulation FRM 08 was coating with fatty acid, as the hydrophobic nature of the fatty acid can interfere with laser diffraction techniques. Fatty acid coating may increase particle size, leading to poorer surface quality and lower gloss.

Formulations FRM 08, FRM 11, FRM 12, and FRM 14 displayed oil absorption rates less than the 30 g/100 g. absorption rate of the aluminum hydroxide (ATH) tested. These oil absorption rates correspond to acceptable processing capability, indicating that formulations FRM 08, FRM 11, FRM 12, and FRM 14 may be substituted for ATH or MDH in some applications. This may, in turn, save costs. Formulations FRM 08, FRM 11, FRM 12, and FRM 14 may also allow the use of higher processing temperatures.

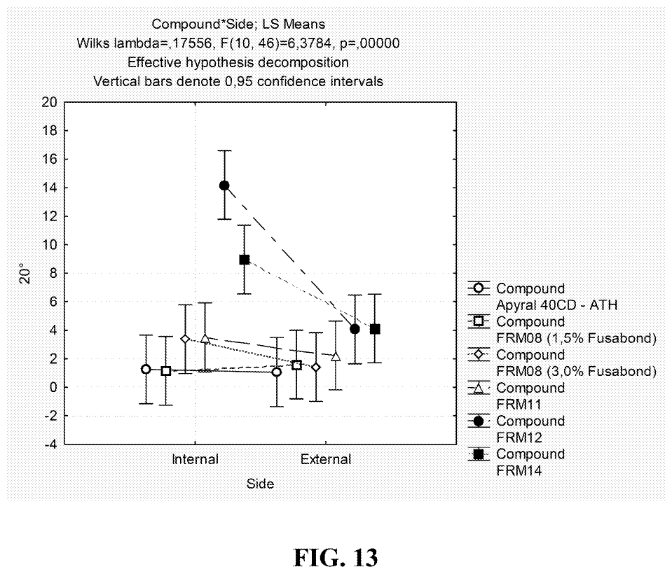

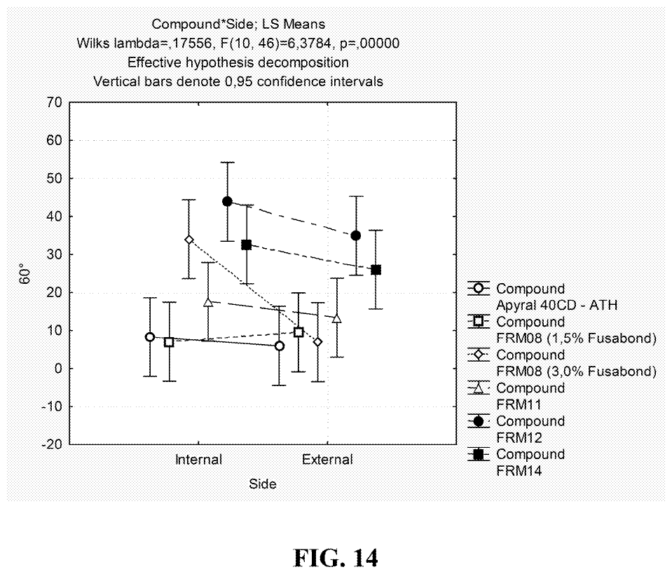

To study the impact of particle size distribution on surface irregularities of extrusion-molded polymers, one sheet of each compound was molded and gloss measured from both sides of the sheets by Glossmeter equipment at angles of 20° and 60°. Both angles were measured considering internal and external side of the sheets, making it possible to identify the influence of composition changes on surface quality while excluding the interference from process variables. This may correlate with performance in extruder equipment. FIGS. 13 and 14 present the results in angles 20° and 60° for polymer compounds.

As shown in FIGS. 13 and 14, formulations FRM 12 and FRM 14 exhibited the highest gloss values. These two formulations included lower particle-size hydrous kaolin treated with an aminosilane coupling agent and untreated dolomite and MDH. The particles of these two formulations were not coated with fatty acid, allowing particle sizes of the dolomite (GCC) and MDH to remain unaltered. The use of formulations with smaller particle sizes for hydrous kaolin and dolomite and without fatty acid led to fewer observed surface defects. Without being bound by theory, the fatty acid coating may lubricate polymer compound surfaces decreasing gloss performance. Coating hydrous kaolin with aminosilane led to improved gloss performance. Formulation FRM 14 exhibited higher gloss despite the presence of silica gel to act as a fire retardant.

As shown in FIGS. 13 and 14, formulations FRM 08 and FRM 11 exhibited higher gloss values than the ATH tested. Both of these formulations included hydrous kaolin, dolomite, and MDH. As summarized in Table 14 and Table 15, however, formulation FRM 11 had lower hydrous kaolin and dolomite D10, D50, and D99 particle size distributions than FRM 08. Formulation FRM 11 exhibited higher gloss values than FR 08. Without being bound by theory, smaller particle size distributions may improve gloss performance and surface quality in formulations coated with fatty acid.

1. A flame retardant polymer composition, comprising:
a mineral blend comprising:
kaolin;
an alkaline earth carbonate; and
magnesium hydroxide; and
a polymer,
wherein the mineral blend is present at a weight percent in a range of 20-80 wt %, and
wherein the polymer is present at a weight percent in a range of 20-80 wt %,
each relative to a total weight of the flame retardant polymer composition.

2. The flame retardant polymer composition of claim 1, wherein the mineral blend comprises
10-50 wt % kaolin;
10-50 wt % alkaline earth carbonate; and
10-50 wt % magnesium hydroxide, each relative to a total weight of the mineral blend.

3. The flame retardant polymer composition of claim 1, wherein the mineral blend is dispersed in the polymer.

4. The flame retardant polymer composition of claim 1, wherein the kaolin is natural kaolin.

5. The flame retardant polymer composition of claim 1, wherein the alkaline earth carbonate is at least one selected from the group consisting of calcium carbonate, magnesium carbonate, dolomite, huntite, and magnesite.

6. The flame retardant polymer composition of claim 1, wherein the polymer is a polyolefin.

7. The flame retardant polymer composition of claim 1, wherein the polymer is an elastomer selected from the group consisting of acrylic rubber, ethylene propylene diene monomer rubber, ethylene propylene rubber, fluoroelastomer, polybutadiene, polyisobutylene, polyisoprene, silicone rubber, and natural rubber.

8. The flame retardant polymer composition of claim 1, wherein the polymer is a thermoplastic polymer selected from the group consisting of acrylic, acrylonitrile butadiene styrene, ethylene-vinyl acetate, nylon, poly(vinyl acetate), polyacrylonitrile, polybenzimidazole, polybenzoxazole, polybenzthiazole, polybutene-1, polybutylene, polycarbonate, polyether sulfone, polyetherether ketone, polyetherimide, polyethylene, polyethylene adipate, polyethylene terephthalate, polyimide, polylactic acid, polymethyl acrylate, polymethyl methacrylate, polymethylpentene, polyoxymethylene, polyphenylene oxide, polyphenylene sulfide, polypropylene, polystyrene, polytetrafluoroethylene, polyvinyl alcohol, polyvinyl chloride, polyvinyl ester, and polyvinylidene fluoride.

9. (canceled)

10. (canceled)

11. The flame retardant polymer composition of claim 1, further comprising less than 5 wt % aluminum hydroxide relative to a total weight of the flame retardant polymer composition.

12. (canceled)

13. The flame retardant polymer composition of claim 1, which is essentially free of halogens.

14. The flame retardant polymer composition of claim 1, further comprising titanium dioxide.

15. The flame retardant polymer composition of claim 1, further comprising 0.01-5 wt % of a fatty acid, a polysiloxane, or both, each relative to a total weight of the flame retardant polymer composition.

16. (canceled)

17. The flame retardant polymer composition of claim 15, comprising both fatty acid and polysiloxane at a weight ratio in a range of 1:1-6:1 stearin to polysiloxane.

18. The flame retardant polymer composition of claim 1, further comprising 0.01-0.05 wt % dicumyl peroxide, relative to a total weight of the flame retardant polymer composition.

19. The flame retardant polymer composition of claim 1, which has a density in a range of 1.1-1.8 g/cm³.

20. The flame retardant polymer composition of claim 1, which has a melt flow rate in a range of 2.0-4.5 cm³/10 min at 150° C. according to ASTM D 1238-10.

21. The flame retardant polymer composition of claim 1, which has a melt flow rate in a range of 47-70 cm³/10 min at 230° C. according to ASTM D 1238-10.

22. The flame retardant polymer composition of claim 1, which has a tensile strength at break in a range of 6-10 MPa according to ASTM D 638-14.

23. The flame retardant polymer composition of claim 1, which has a tensile strain at break in a range of 15-40% according to ASTM D 638-14.

24. The flame retardant polymer composition of claim 1, which has a UL94 flammability rating of V-0 or V-1.

25-34. (canceled)
